(19) United States
(12) Patent Application Publication
(10) Pub. No.: US 2006/0013556 A1
(43) Pub. Date: Jan. 19, 2006

(54) Commercial information and guide

(76) Inventor: Thomas Poslinski, Elma, NY (US)

Correspondence Address: MILLER PATENT SERVICES, 2500 DOCKERY LANE, RALEIGH, NC, 27606, US

(21) Appl. No.: 10/882,577

(22) Filed: Jul. 1, 2004

(51) Int. Cl. H04N 5/781

(52) U.S. Cl. 386/46; 386/125

(57) ABSTRACT

Various aspects of television commercial handling are presented. Television commercials are identified in a transport stream that contains commercial data. The commercials are stored and retrieved from a folder in a PVR-like device. A database of commercial information is build for easy retrieval of the commercials. Commercials can be flagged with restrictions against trick play. Various user interface mechanisms are described. This abstract is not to be considered limiting, since other embodiments may deviate from the features described in this abstract.

### CROSS REFERENCE TO RELATED DOCUMENTS

This application is related to the following applications which are filed of common date herewith and which are hereby incorporated herein by reference:
Docket Number SNY-T5863.01, to Poslinski, Ser. No. ______;
Docket Number SNY-T5864.01, to Poslinski, Ser. No. ______;
Docket Number SNY-T5871.01, to Poslinski, Ser. No. ______;

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Television commercial messages (commercials) have become a common way to advertise products, manufacturers, services, politicians, charities, etc. on behalf of their sponsors. Certain television commercials may also be informative, educational or entertaining, and may be worthy of retaining for future viewing. For example, certain television commercials may contain historically significant political messages, while others may be entertaining but may only be shown during the annual Super Bowl. Other commercials may be bothersome and/or uninteresting.

With the advent of personal video recorders (PVRs—i.e., disc drive based recorders) and to some extent video tape recorders (VTRs), the user is somewhat able to control viewing of television programming, by time shifting the programming and using trick play modes such as “fast forward” to mostly skip commercials in programming if the user desires. This is an issue for broadcasters who are compensated by the sponsor, and wishes for the commercial to be presented to the viewing audience.

In the case where commercials may be of interest to the viewer, mechanisms for commercial handling have not been devised to assist in organizing or reorganizing the commercials.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 illustrates a data stream consistent with certain embodiments of the present invention.

FIG. 2 is a flow chart describing an exemplary method for processing of commercial offers in a manner consistent with certain embodiments of the present invention.

FIG. 3 is a flow chart describing an exemplary method of selecting commercials and saving them in a manner consistent with certain embodiments of the present invention.

FIG. 4 illustrates an exemplary screen shot of a search criteria setup screen consistent with certain embodiments of the present invention.

FIG. 5 illustrates an exemplary database search screen consistent with certain embodiments of the present invention.

FIG. 6 illustrates an exemplary database search results screen consistent with certain embodiments of the present invention.

FIG. 7 is a flow chart depicting an exemplary commercial viewing method consistent with certain embodiments of the present invention.

FIG. 8 is a flow chart depicting an exemplary method for looping commercial viewing consistent with certain embodiments of the present invention.

FIG. 9 illustrates an exemplary program guide type screen consistent with certain embodiments of the present invention.

FIG. 10 illustrates an exemplary commercial guide category screen consistent with certain embodiments of the present invention.

FIG. 11 illustrates an exemplary commercial guide screen consistent with certain embodiments of the present invention.

FIG. 12 illustrates another exemplary commercial guide screen consistent with certain embodiments of the present invention.

FIG. 13 illustrates another exemplary commercial guide screen consistent with certain embodiments of the present invention.

FIG. 14 illustrates an exemplary commercial screen view consistent with certain embodiments of the present invention.

FIG. 15 illustrates an exemplary screen displaying a commercial description consistent with certain embodiments of the present invention.

FIG. 16 illustrates another exemplary screen displaying a commercial description information consistent with certain embodiments of the present invention.

FIG. 17 is a flow chart depicting trick mode control in a manner consistent with certain embodiments of the present invention.

FIG. 18 illustrates an exemplary commercial progress bar consistent with certain embodiments of the present invention.

FIG. 19 illustrates an exemplary magnified commercial progress bar consistent with certain embodiments of the present invention.

FIG. 20 illustrates another exemplary magnified commercial progress bar consistent with certain embodiments of the present invention.

FIG. 21 illustrates a time line for a television program including commercials in a manner consistent with certain embodiments of the present invention.

FIG. 22 illustrates a reordering of commercial presentation consistent with certain embodiments of the present invention.

FIG. 23 is a flow chart of an exemplary commercial listing process consistent with certain embodiments of the present invention.

FIG. 24 is an exemplary block diagram of a PVR/DVR device consistent with certain embodiments of the present invention.

### DETAILED DESCRIPTION

While certain embodiments consistent with this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The term “commercial” is used to mean any television programming (generally paid for by a sponsor, but possibly unpaid) that is designed for advertising purposes or to promote a product, service, policy, political candidate, etc. Television commercials are typically short clips of 10 seconds to 1 minute that occur during a television program or between television programs.

The term Personal Video Recorder (PVR) or Digital Video Recorder (DVR) are used synonymously herein to mean a recorder that is hard disc drive based or otherwise uses a storage mechanism that permits random access of the stored information. While the PVR is used as an example throughout, any digital television receiving device with similar functionality is considered to be the same or equivalent.

The present discussion presents a number of illustrative user interface screens as might be depicted on a television display. It should be carefully noted that these screens are shown by way of example and not limitation. Many different screen arrangements can be utilized to accomplish the same or similar purposes without departing from embodiments consistent with the present invention. Accordingly, such screens should be considered to be illustrative of one exemplary screen without limitation.

The following is a discussion of the various aspects associated with commercial handling using a PVR or DVR type device or equivalent.

Recording Commercials to a Folder

Currently, the recording of commercials is difficult because the commercials have no scheduled times that a video recorder can synchronize to. In accordance with certain embodiments consistent with this invention, a digital transport stream can be used to transport synchronization points which allow for the recording of individual commercials. Along with allowing synchronization, auxiliary data can be transmitted. This auxiliary data can be of any suitable protocol understood by a television set-top-box (STB) or the television itself such that the set-top-box can translate data from the protocol into a graphical user interface to supply supplemental information during playback of the commercial after it has been recorded by the PVR/DVR application. These special offers can be viewed during playback of a recorded commercial. Data can be collected by the PVR/DVR application and transmitted back to the service provider through a back channel such as a cable modem connection. An offer symbol can be displayed during the preview of a commercial indicating to the user that an offer exists, allowing the user to record the commercial.

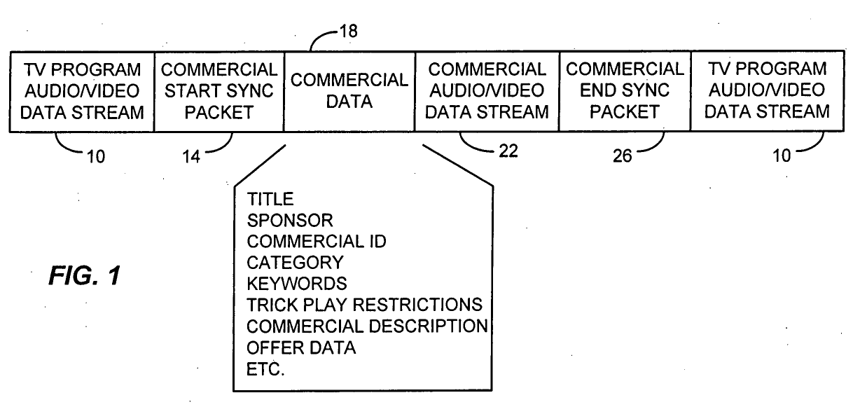

An exemplary transport stream carrying digital television video as well as commercials and commercial data is illustrated in FIG. 1. In accordance with this illustrative embodiment, a television (TV) program audio and video (A/V) segment 10 of a data transport stream is interrupted by a television commercial. The beginning of the commercial segment is signaled by a commercial start packet 14. This start packet 14 signifies that a commercial message is starting or identifies a beginning time or packet number for the start of a commercial A/V stream to follow. In one embodiment, the commercial has one or more associated commercial data packets 18 carrying information about the commercial that can be used in many ways as will be described later. In other embodiments, the commercial data can be carried in the commercial start packet 14, and may be duplicated in the commercial end packet 26. The commercial data packet(s) 18 may contain any number of data fields used by the recipient including, for example, a commercial title, sponsor, commercial identifier (CID), a commercial category, key words, an offer flag to identify special offers, special restrictions on playback such as trick play restrictions, a commercial description, and/or other information.

The commercial message itself is contained in a stream of A/V data 22. The end of the commercial is signified by a commercial end synchronization packet 26 that itself signifies the end of the commercial or identifies an end point for the commercial. The television program data stream 10 resumes after the end of the commercial.

The transmission of an offer and synchronization data can be accomplished in at least two ways. In a first embodiment, auxiliary packets of a MPEG-2 Video stream can be used to indicate start, stop, and offer data as shown above, with, for example, the offer data contained in one or more of the commercial data packets 18. The auxiliary packets are imbedded data information packets 18 multiplexed on the same information stream as the television program's video stream 10. In this case, if a PVR/DVR application is recording the video stream, the commercial stream is automatically recorded also.

In a second embodiment, an independent commercial stream can be transmitted separate from the video stream. That stream has an independent PID (Program Identification) identifier that a PVR/DVR application must record. In either case, synchronization can be accomplished by transmitting one packet of transport data on the auxiliary stream at the precise time that a commercial is to begin.

The information in the commercial data packet(s) 18 can include standardized information about the commercial. For example, the title, manufacture, commercial identification, PTS (Presentation Time Stamp) of the beginning and end of the commercial, offer flag, etc.

The second synchronization packet (end) of transport data 26 on the auxiliary stream can be transmitted at the precise time that a commercial is to end. Offer data can be transmitted between the synchronization start transport packet 14 and the synchronization end transport packet 26 of a commercial. The PVR/DVR application can determine if offer data is present by reading the data in the start synchronization transport packet 14. Alternatively, the offer data flag can appear in the commercial data packets 18 as shown.

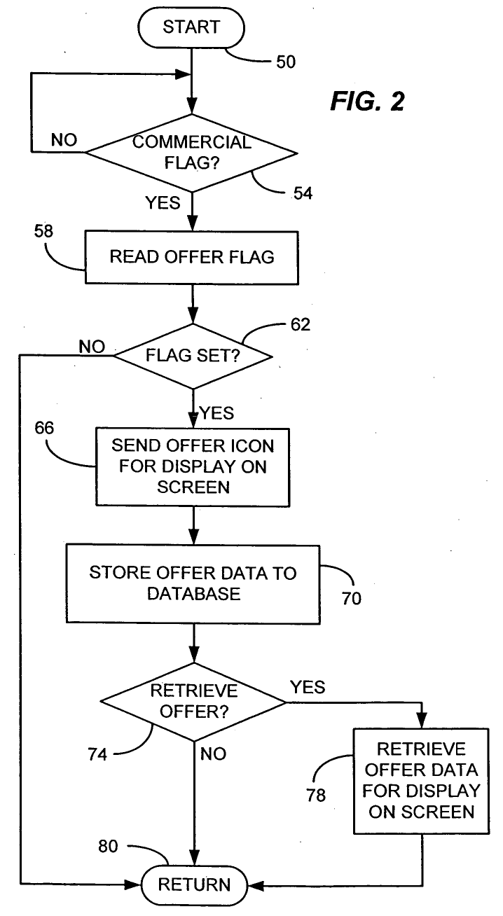

Offer handling can be as depicted in FIG. 2 in accordance with certain exemplary embodiments starting at 50. Whenever start commercial flag is received (or commercial data flag received) at 54, the offer flag is read at 58. If the offer flag is set at 62, an offer symbol can be graphically displayed on the television screen by sending an appropriate icon for display at 66. If the commercial stream is recorded by the PVR/DVR application, the preview of a recorded television program can render the same offer symbol for a commercial during playback. When the commercial is stored on a PVR, the offer data may also be stored in an appropriately indexed database at 70. The user can use the record button during playback to record a commercial. The user can view details of the offer (i.e., view the offer data) by making an appropriate selection from a user interface (e.g., a remote controller) to retrieve the offer. If the offer is to be retrieved at 74, it is retrieved at 78 and displayed on the television screen. If the flag is not set at 62, or no offer is retrieved, or subsequent to retrieval of the offer, the process returns at 80.

A commercial folder (subdirectory) on the PVR disc drive can be used to separate the recordings of commercials into a separate folder so as not to mix the recordings in between television programs on the recorded program list screen. Thus, a commercial list can be rendered for the user to choose a commercial for playback.

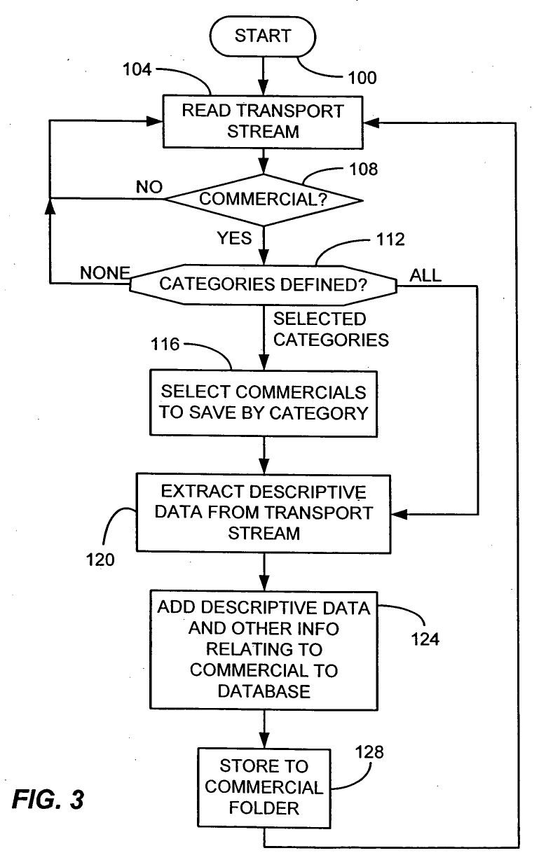

FIG. 3 illustrates one embodiment of a process for storing data to a folder of a PVR's disc drive along with building and storing a database of commercials to the disc drive. This process starts at 100 after which the transport stream is read at 104 until a commercial is encountered at 108. In accordance with certain embodiments consistent with the present invention, commercials can be stored according to categories or other criteria (illustrated in this figure as categories only, but not limited as such) defined by the user. If categories (or other criteria) have not been defined at 112, the commercial is not recorded. On the other hand, if selected categories have been defined for selection from the transport stream, the commercial is inspected to see if it meets the defined criteria or category at 116, and appropriate matches to the criteria are selected at 116. Control then passes to 120. If all commercials are to be recorded, control passes directly to 120 from 112, bypassing 116.

At 120, the descriptive data in the commercial data packet 18 is extracted from the commercial data packet and added to other information relating to the commercial into a database at 124. The commercial itself (possibly including the raw commercial data) is then stored at 128 into the folder (subdirectory) of the disc drive. After 128, control returns to 104 to await receipt of the next commercial. If, at 112, no categories have been defined for selection, no commercials are saved and no data entered into the database.

When a commercial is selected, either live or after storage in the PVR, the title and all necessary information can be displayed for the user. The user can also display an offer, if one exists, through an on-screen interface or via a button on a remote control. When this selection is made by the user, the PVR/DVR application reads the recorded offer data and decodes the data stream and displays an offer that a user can interact with. The maintenance of commercials recorded can be through control buttons on a user interface or via soft or hard buttons on a remote control.

In certain embodiments consistent with this invention, a standard PVR/DVR application is assumed. The service provider of the transport data can provide an auxiliary transport stream representing the commercial data stream. The service provider can identify the location the auxiliary transport stream by use of a service identification table. This service identification table can provide the stream identifiers for the audio, video, ECM, and commercial streams. When a user changes channels, the service identification table is read and the commercial stream identifier is extracted. The PVR/DVR application record engine can be set up to record the audio and video stream data along with the commercial data stream identified by the commercial stream identifier. The PVR/DVR application now can monitor the commercial data stream for a synchronization start packet. When seen, the current commercial can be recorded by the user.

When a record operation is initiated by the user, the commercial data can be copied to a separate commercial file identified by the commercial name identified in the start synchronization packet. If the complete commercial has not yet been received by the PVR/DVR commercial, the copy can begin once all of the data are received. All commercial video data is known to be recorded by reading the start synchronization packet which contains that start time and end time of the commercial.

The same time stamps can be used in a video stream to synchronize audio and video. That timing can be used to set the boundaries of a commercial. A commercial end synchronization packet 26 can signify the end of a commercial and can contain the same information that a start synchronization packet 14 contains. The commercial end synchronization packet 26 is redundant data for the recording of commercials. The redundant information can be used during signal loss conditions in which a start synchronization packet 14 is lost.

During playback of a television recording a user may be allowed to fast forward past or rewind past a recording. But if a user stops in the middle of a commercial, the start or stop synchronization packet can not be seen. Note that during the recording of a commercial data stream, the relative position of the commercial data stream packets is lost because the stream is recorded into a separate file. In any case, the PVR/DVR application can store the commercial data stream as a continuous file and can monitor this file during playback for bounding commercial times. During playback the file can be read and the next commercial start and end time can be cached. When that time passes during playback, the PVR/DVR application can know what commercial is currently playing. Thus, during fast forward or fast rewind through the commercial, any video frame displayed has a time stamp. That time stamp can be checked against the next and previous commercial that the system is looking for. If the time stamp falls in that range, the PVR/DVR application knows it is in the boundary of a commercial, and the offer symbol can be display even if the user is fast forwarding or fast rewinding through the playback.

Once a user is in the bounds of a commercial, the PVR/DVR can calculate by reading the commercial data stream file, the next and previous commercial in the stream. The bounding times can be known for monitoring during playback. When a user hits the record button during playback, the commercial can be copied in its entirety to a separate file. If there is an offer, the offer data stream can be copied out of the television program recording into the commercial file recording. Once copied, the commercial file can be made accessible to the user in the commercial folder screen. The synchronization packets can contain any or all of the following:

(a) Start Synchronization—This is used to signify that this packet is the start of a synchronization data packet. This value is a fixed integral number to identify the start of a synchronization packet.

(b) Commercial Identifier—This is usually an integral number identifying the commercial through one reference point. Using this number, a PVR/DVR application can prevent the recording of multiple instances of the same commercial. Note that the same commercial can be transmitted with different identifiers when different offers are offered to the user. The identification can be used when reporting to service provider, allowing the service provider to communication with the user more accurately.

(c) Commercial Title—This is the title of the commercial transmitted as a string of characters. The commercial title can be used by the PVR/DVR application to identify the commercial on the commercial playback selection screen.

(d) Manufacture—This the name of the manufacture transmitted as a string of characters. The manufacture string can be used to identify the name of sponsor.

(e) Start Time Stamp—This is the PTS (Presentation Time Stamp) of the start of the commercial in the stream. It is relative to the PTS that is transmitted in the audio and video stream. When a frame in the video stream matches this time stamp, the start of the commercial is assumed.

(f) End Time Stamp—This is the PTS (Presentation Time Stamp) of the end of the commercial in the stream. It is relative to the PTS that is transmitted in the audio and video stream. When a frame in the video stream matches this time stamp, the end of the commercial is assumed.

(g) Offer Flag—This is a flag that indicates that offer data is present. When set the offer data is recorded from the commercial data stream. This data are used by the PVR/DVR application to render an interactive graphical interface to offer some special incentive.

Note that the end synchronization packet is the same as the start synchronization packet accept for the first snippet of information representing the start synchronization identifier. An end identifier is present in the end synchronization packet.

Commercial Recording Based on Criteria

A typical PVR/DVR application does not record commercials as part of its feature list. Since a typical commercial duration is in the range of 10 seconds to 60 seconds, a great number of commercials can be recorded without taking up to much space on a PVR's hard disc drive. In certain embodiments consistent with the present invention, a preference engine can be set up to automatically record key commercials for a user. A key commercial is defined, for example, as a user defined category and key word matched commercial. A user may wish to record all cat food promotions currently being aired. A user may set-up a category of “Pet food” and a key word “cat”.

As commercials are aired, the PVR/DVR application can scan a commercial data stream, as defined above, match a category, and scan for key word in the key word list of a commercial data packet 18 of the commercial data stream. In another embodiment, the commercial data stream start/end synchronization packets 14 and 26 can be augmented to include key words for a commercial. If there is a match, the PVR/DVR application can automatically copy the commercial from the current stream file into a commercial file stored in a commercial folder of the PVR/DVR. The title can be relative to the commercial name given in the start/end synchronization packet. This process has been described in connection with FIG. 3.

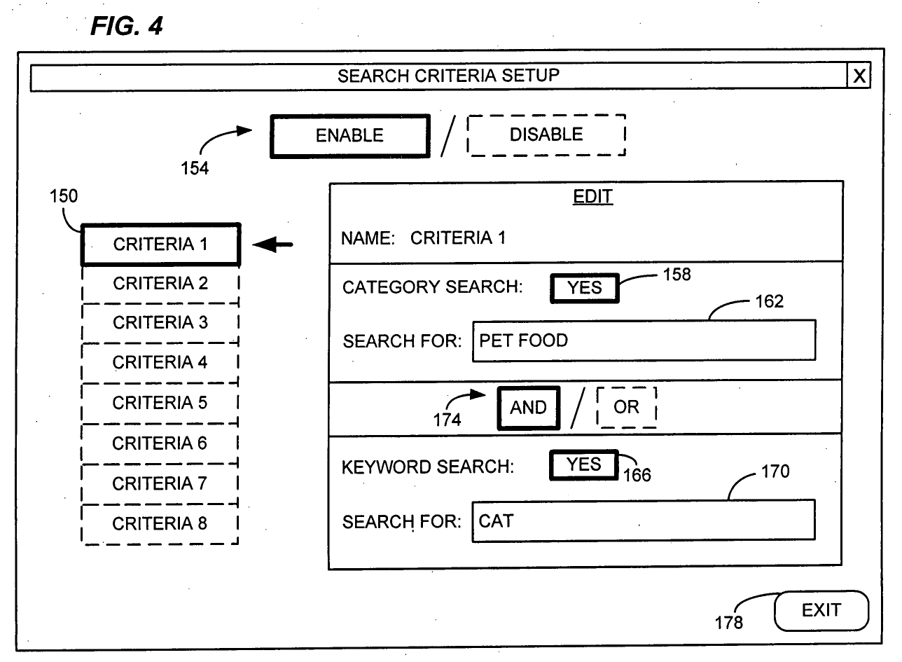

In accordance with certain embodiments consistent with the present invention, a standard PVR/DVR set-top-box application or digital television receiver application incorporating PVR-like functions is assumed. A user interface setup screen can be added to allow the user to setup the automatic recording of commercials as illustrated in FIG. 4. On this screen, the user can be able to setup multiple search criteria, for example, eight criteria are shown with “CRITERIA 1” shown as highlighted using conventional techniques for interaction with a television on-screen user interface via a remote control or similar device. Each search criteria can be a category only criteria, category and/or key word criteria, or key word only criteria.

In this example, the user has enabled the search criteria process by toggling the “ENABLE/DISABLE” selection 154 to “ENABLE”. Under “criteria 1” in the edit box, the user can then enable a category search by toggling the selection 158 to “YES” and entering a category name into text box 162. In certain embodiments, the entries in box 162 can be predefined and the user simply scrolls through the available categories. In other embodiments, the categories are manually entered. In a similar manner, a keyword search can be enabled by toggling selection 166 to “YES” and entering one or more key words into box 170. In certain embodiments, the category search and key word search are automatically joined using a logical “AND” search operator, and in other embodiments, the joining of the search criteria can be done either by a logical “AND” or by a logical “OR” operator as shown. In this case, the logical operator selection 174 is made to be a logical “AND” operator so that both the keyword and the category must be satisfied in order for a search candidate to qualify as matching the criteria 1. Once all desired criteria are established, the user can exit using exit button 178.

The PVR/DVR application can store the list of search criteria, for example in non-volatile memory, as a list of criteria for the recording of commercials. The user can also be able to enable or disable the automatic recording of commercials. Once a list is setup, the PVR/DVR application can monitor all live recordings in accordance with the process depicted in FIG. 3. As television programs are recorded, a commercial data stream is transmitted in conjunction. The PVR/DVR application can monitor the commercial data stream. The PVR/DVR application can extract the category and key word list for each commercial. The search criteria list can be extracted, for example, from non-volatile memory. A comparison can be done for each search criteria against the current commercial category and key word list. A comparison can be performed only on the selected types of a search criteria entry defined at setup, i.e. category only, category and key word, or key word only.

If a match exists, the current commercial can be copied from the current record stream into a separate file and stored in the commercial folder. The filename of the file can be based on the title of the commercial extracted from the start/end synchronization packet. The file can be stored in a folder on the hard drive specified for a commercial folder. The commercial folder name can be any desired name given by the manufacture of the PVR/DVR application. Once stored in the commercial folder, a user interface screen can be provided to access the list of commercials stored. The list of recorded commercials can be further separated by category when being displayed for the user. During this scenario, the PVR/DVR application can read the meta-data of each file in the commercial folder and extract the category. The list of files presented to the user can then be category based. The viewing of the commercial begins when a user selects a title from the commercial title list. The maintenance of the commercial folder can be provided in any suitable manner. A user interface delete option on the commercial title list user interface page can be provided to the user to delete the commercial

Commercial Database

As previously noted, commercials in television programs can provide valuable information for a user. Current PVR/DVR applications record television programs with commercials embedded in the program. None of the PVR/DVR applications record commercials individually and present them to the user. The customary method for searching for a commercial is by opening up a recording for viewing and fast forward to find commercials. In accordance with certain embodiments consistent with the present invention, a database of recorded commercials can be created to allow users to easily access any commercial recorded. In certain embodiments, the commercials do not have to be individually recorded; they can be recorded within a recorded television program. As a television program is recorded permanently onto the PVR hard disc drive, a commercial data stream is monitored to detect when commercials are transmitted. If a commercial is detected by seeing a start synchronization packet, the data from the commercial data packet 18 (or the start synchronization packet 14) can be extracted and stored in a database as a commercial instance in the database. The following are examples of entries can be stored for each commercial database entry. Other entries may occur to those skilled in the art upon consideration of the present teaching.
(a) Commercial Identifier—This is a unique identifier of a commercial in the commercial data stream. It can be used as the search key in a database application.
(b) Commercial Title—The title of the commercial.
(c) Commercial Description—A description string of the commercial.
(d) Category—Identifies the category of the commercial as pre-defined by the service provider or any other understood standard for category types.
(e) Key Words—A list of key words that apply to the content of the commercial.
(f) Record Filename—This is the filename of the original recording that contains this commercial. This can be a list of filenames if the same commercial is seen in different recordings.
(g) Start Time—The start time identifies a start presentation time stamp de-referenced into the original television recording. This can be a list of start times indexed to match the index of filenames.
(h) End Time—The end time identifies an end presentation time stamp de-referenced into the original television recording. This can be a list of end times indexed to match the index of filenames.

The commercial identifier uniquely identifies each commercial entry. A user interface screen can be provided to search and display a list of recorded commercials.

Any number of criteria can be specified for searching the database. For example:
Category search—category matching against the database entry category.
Key word search—any number of key words to match against the database entry key word list.
Recorded program search—search for commercials by selecting a recorded television title and extract only those commercials that exist in that recording.
Commercial Title search—string search against the database entry title strings.

Note that the user interface search criteria can be any one of the above, and any combination of the above. When the search is complete, search results can be displayed to the user for viewing. When a recorded television program is deleted from a PVR/DVR set-top-box, the commercial database can be updated by reading the commercial data stream stored for the delete file; all of the commercial identifiers can be extracted from the commercial data stream. Those identifiers along with the filename of the deleted television program can be presented to the database manager. The database manager can extract the database entry referenced by the commercial identifier. The filename can then be compared to the entry filename. If the filename is found, the filename entry in the database entry can be deleted along with the start time and end time associated with the filename. If no filenames exist for a database entry at this point, the entire database entry can be deleted from the database.

A standard PVR/DVR set-top-box application can be modified to incorporate a database manager software package to allow for database management of the commercial database. Upon initial startup of the PVR/DVR set-top-box application, the television commercial database can be initialized and no entries can exist in the database. As television programs are recorded for the PVR/DVR application, the PVR/DVR application can monitor the commercial data stream for start/end synchronization packets 14 or 25 and/or commercial data packets 18. These packets can signal the location of a television commercial within a television recording. When a start/end synchronization packet 14 or 26 is received it can be processed. The Commercial Identifier, Commercial Title, Commercial Description, Category, Key Words, Start Time, and End Time can be extracted. Depending on the embodiment, this data can appear either in the start packet 14 and/or the end packet 26, or can appear in the commercial data packet 18 as previously described. Alternatively, certain of the data can appear in the various packets.

A query to the database manager of the commercial database can be made to see if an entry exists for the Commercial Identifier. If one exists, the filename of the current recording, the Start Time, and End Time can be presented to the database manager to append to the entry identified by the Commercial Identifier. If one does not exist, then a new entry can be created by the database manager with an identity identified by the Commercial Identifier. This new entry can contain the extracted elements of the start/end synchronization packet and the currently recorded filename. Note, since both a start and end synchronization packets contain the same information, both will be processed just in case one or the other is lost due to signal loss. In any case, duplicate entries can not exist in the database.

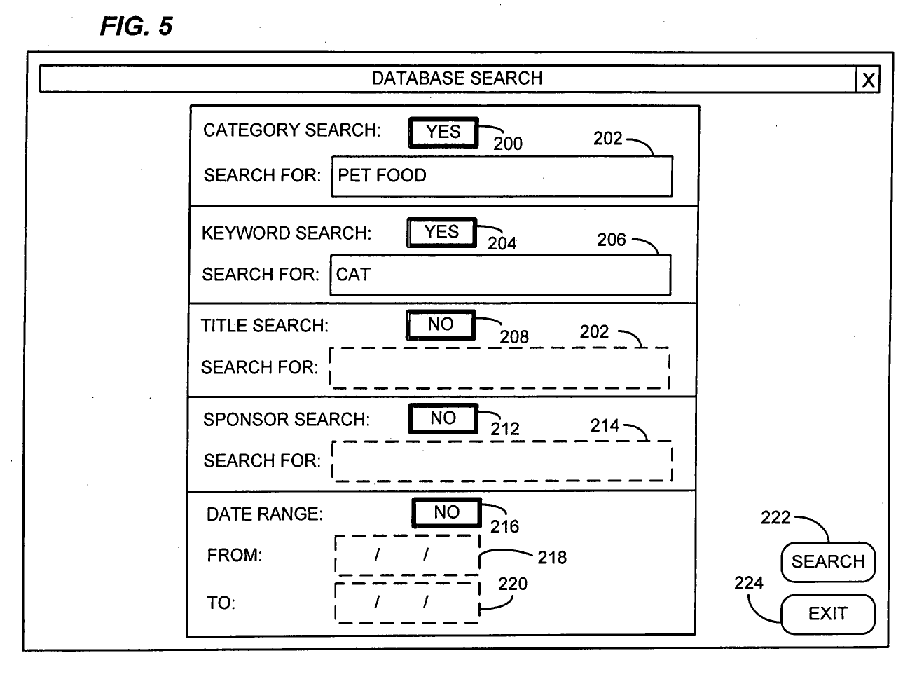

A user interface screen can be provided as depicted in FIG. 5 to search the database using different criteria as described above. This user interface screen can contain user input sections which will allow the user to select a category for a category search at 200 and enter a search category at 202, select a key word search at 204 and input a key word or words at 206, select a title search at 208 and input a search title fragment at 210, or allow the user to select a pre-recorded program title from a list of recorded television commercials at 210, or select a sponsor name search at 212 and enter names or fragments at 214, or to select a date range at 216 and enter beginning and/or ending dates at 218 and 220. Any number of combinations of the above can be specified by the user for the search.

In the example screen shown in FIG. 5, a category and key word search are active while the title, sponsor and date searches are inactive. Operation of this screen is similar to the previous screen with the “YES/NO” boxes being toggled to make a selection and the other boxes being user editable by any suitable mechanism. The search is initiated with the search button 222, or the user can exit this screen by button 224.

During a category search, each entry in the database can be extracted and the category stored in the entry can be compared against the category requested. During a key word search, each entry in the database can be extracted and each key work for each entry can be compared against each key word specified for the search. During a title search, each entry in the database can be extracted and the title fragment specified by the user can be compared as string in string compare against the commercial title, thus the title fragment string can be anywhere in the commercial title.

If a recorded television title is used for the search, the title can be cross referenced to a filename; each entry in the database can be extracted and the filename list can be compared against the filename referenced. After the search is complete, a list of commercial titles can be generated for the user on a user interface screen. The user can be able to traverse through the list of commercial titles and can be able to select a title for viewing. For each title, the description of the commercial can be provided to the user before viewing on the user interface screen containing the commercial titles. When a title is selected, the corresponding database entry can be extracted and the filename, start time, and end time can be extracted. The filename file can be opened; the start time can be searched in the list of start time for the filename, a byte offset for the start time can be determined from the start time table stored for recorded program. The byte offset is from the beginning of a file. The first key frame seen at that byte offset can be used as the start of the commercial. As the video plays for the user, representing the commercial, the time stamp for each frame presented can be compared against the end time of the commercial. If the end time is observed, the video playback can stop, the file can be closed, and the user can be returned to the user interface screen for selecting another commercial. Note a user can be able to fast forward and reverse through the commercial.

When a user deletes a television program from the PVR/DVR set-top-box using standard delete mechanisms, the database can be updated to reflect the deletion. The PVR/DVR application can read the commercial data stream stored for a file. The Commercial Identifier for each commercial can be extracted. A request to the database manager can be made to extract the commercial database entry for the Commercial Identifier. The filename can be searched for in the filename list of the database entry. If found, the filename and the associated start time and end time can be deleted from the entry. If no other filenames exist for the commercial entry, the commercial database entry can be deleted from the commercial database. If other filenames exist for the entry, the database entry can be updated to reflect the deletion of the filename.

Category Search of Commercials

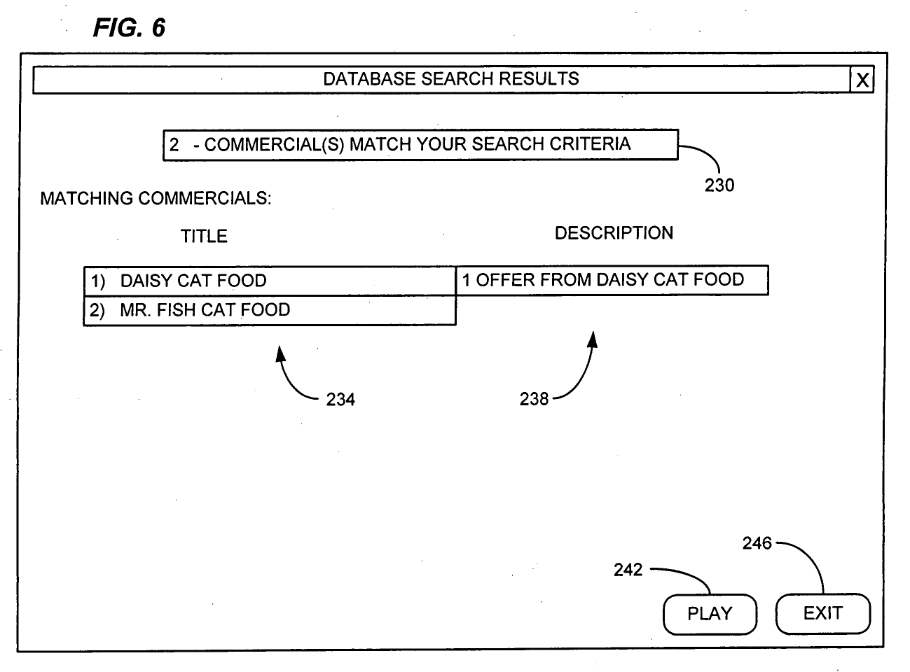

Referring to FIG. 6, the results of the search may be presented, for example, as shown. In this screen, the number of “hits” based on the search criteria is shown at 230. The title, sponsor or other identifier can be displayed in column 234 and any special offers associated with the commercial can be shown in column. A commercial or offer can be selected from the list shown in column 234 or 238 and played out by use of button 242. The screen can be exited by use of button 246.

Thus, in this embodiment, the user can setup a category and/or key word search for commercials. Using the commercial data stream, as defined, category and key word searching can easily be accomplished. Once all of the files on the hard disc drive are scanned, a list of available commercials can be provided to the user for previewing. The commercial can then be viewed directly from the recorded television program.

A user interface screen similar to the screen shown above can be provided to search for commercials in previously recorded television programs. The user interface screen can allow the user to specify a category and/or key word for the search. Once the entries are finalized, a user interface button can initiate the search. The current or a second user interface screen can be used to display the search results. The PVR/DVR application can record the commercial data stream data into the meta-data portion of the television record file stored on the hard disk drive. During the search, the PVR/DVR application can open up each previously recorded television program file and read the meta-data. It can parse the meta-data and look at every commercial data stream start/end synchronization packet stored for a file. It can then extract the category and key word list and match the user input category and key word. If a match exists, the PVR/DVR application can read and store in a list of matched commercials, the title, filename where the commercial exists, description, and the start time and end time in the stored file of the commercial. Once all of the files on the hard disk drive are searched, the list can be presented to the user as a list of titles. The user can then be able to scroll the list and get descriptions for each commercial. Upon selecting a commercial, the user can be able to view the commercial. The PVR/DVR application can note the filename, start time, and end time of the commercial. The PVR/DVR application can open the file for reading, it can cross reference the start and end time to a byte offset into the file, the read pointer can be positioned at the byte offset cross referenced to the start time, it can start playback, and subsequently stop playback and return to the commercial list screen when playback hits the byte offset represented by the end time. When the playback finishes for a commercial, the open file can then be closed.

Viewing Continuous Loop of Commercials

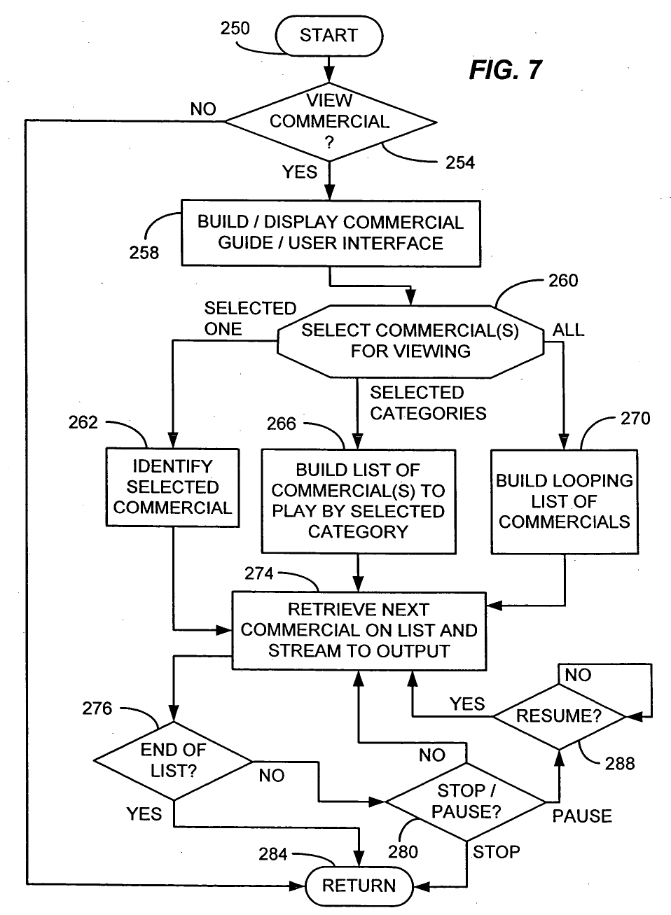

When a user wishes to play back a commercial or group of commercials, any one of several selections can be made using an appropriate user interface. FIG. 7 depicts operation of an exemplary embodiment of playback of the commercials starting at 250. If a user elects to view one or more commercials at 254, a user interface is built to display the available options for display of the commercial(s) at 258. In one embodiment, for example, in a manner similar to selection of a television program from an electronic program guide, a commercial program guide can be presented to the user. A selection process then ensues at 260.

If the user wishes to simply view a single commercial, the user can select this commercial from a list or from the commercial guide for playback at 262. Another possibility is that the user can select a category from the commercial guide or from a list at 266 for playback. A third possibility is that the user may wish to build a list of commercials for continuous viewing in a loop at 270. Other possibilities also exist, but these should give those skilled in the art an adequate basis for understanding of the concept.

In either case, the selected commercials can be identified and stored as a list of commercials for playback (perhaps only a list of one). The first commercial is then retrieved from the list at 274 and streamed to the output. If the end of the list is not reached at 276, and no stop or pause command has been issued by the user at 280, control returns to 274 upon playing the first commercial where the next commercial on the list is retrieved and streamed to the output. If the end of the list is reached at 276 or a user stop command has been entered at 280, or the user exits the process at 254, the process returns at 284. If a pause command has been entered by the user at 280, the process pauses until resumed at 288.

In this manner, the user may select playback of commercials in any number of ways. It should be noted that this embodiment assumes the presence of a database that can be used to access the commercials. However, in certain embodiments, the system need only extract a list of commercial titles that can be presented to the user if desired in order to simplify the system at the expense of flexibility.

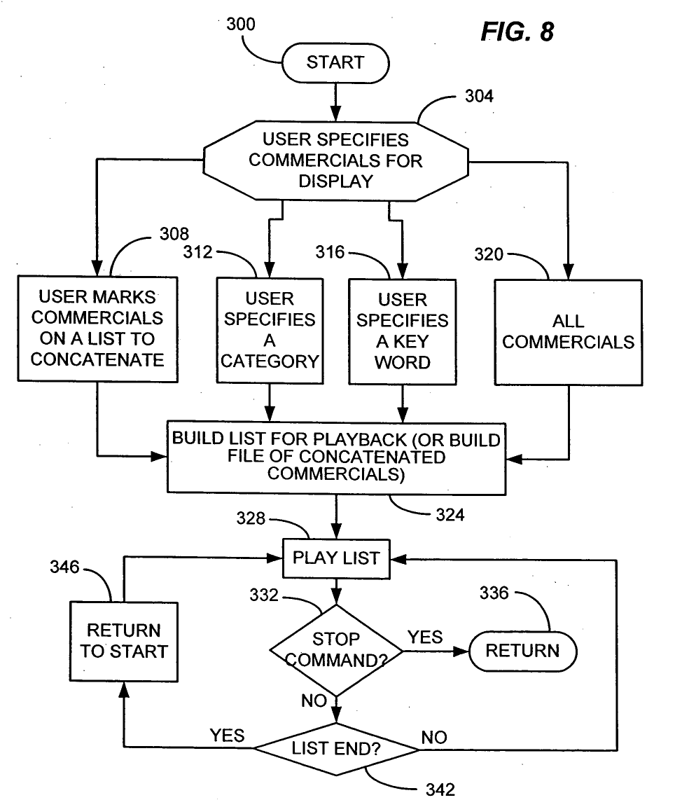

If a continuous stream of commercials is to be generated by concatenating the commercial recordings for a user, there are a number of ways of selecting the commercial for continuous display. FIG. 8 provides several examples of such selection processes starting at 300. At 304 the user initiates a user interface that permits selection of commercials for looping. The user can then select any of several mechanisms for selection of commercials. At 308, the user can mark individual commercials from a list or commercial guide screen of commercials to concatenate. At 312, the user specifies a category and all commercials matching the category are concatenated. At 316, the user specifies key words and all commercials matching the key words are concatenated. At 320, all the commercials may be concatenated. Any number of commercials may be concatenated at a time, subject to hardware or memory limitations.

Once the user makes the specification of the commercials, a list can be built for playback (or in the alternative, the commercials can actually be concatenated to a file for playback) at 324. The commercials from the list are then played back in the order of the list at 328 until a stop command is issued by the user at 332, at which point the process returns at 336. When the end of the list is reached at 342, the list is reinitialized at 346 (by returning a pointer to the top of the list, for example), and play continues in a continuous looping manner until stopped.

Thus, any number of selection criteria can be used to select commercials for continuous viewing. Any combination of the above can be used to generate a continuous commercial video stream. The duration of the continuous viewing can be summation of the individual commercial durations included in the concatenation. A transition filter can be applied between commercials in the continuous commercial stream in certain embodiments. The filter can fade out the end of a commercial, and fade in the beginning of the next. A sufficient amount of time, for example 2 seconds, of blank video can be added in between two commercials so as to prevent discontinuous frame transitions. A progress bar can be shown to indicate the full duration of the current viewing session and the current position of the playback. Delineation markers can be added to indicate boundaries of commercials on the progress bar.

A specific delete sequence can be specified to directly delete commercials during a continuous view session. If a commercial is deleted, the progress bar can be updated to the duration, the delineation marker offsets can be adjusted, the current recording can be stopped and deleted, and the next commercial can be opened and playback can resume. During any commercial viewing session, trick modes can be enabled to allow a user to quickly preview all commercials in the concatenated commercial viewing session. All trick modes can be enabled during this viewing session, including fast forward, rewind, pause, and slow motion.

Many variations in this process will occur to those skilled in the art upon consideration of the present teaching. The continuous viewing feature can be implemented using a user interface screens that allow the user to create a continuous record session. The first user interface screen can allow the user to select the type of search to perform. By way of example, the following types can be provided:
(1) Category and Key Word presentation.
(2) Title selection presentation.
(3) All Commercials.
(4) Interval commercials.
(5) Date range commercials.

In the Category and Key Word presentation search criteria, a user can be allowed to specify a category and/or a key word list. Once the selection has been made, a viewing session can begin by allowing the user to select a button on the user interface screen to continue to view the session. Upon selecting viewing, the PVR/DVR application can search the commercial database for all entries that match the category and/or key words selected by the user. Each commercial that matches the criteria, the filename, start time, and end time can be read and added to a playback list. Once all commercials have been processed in the commercial database, the PVR/DVR application can begin playing with the first commercial on the list. Playback can continue until the last frame of the last commercial in the playback list is presented.

In title selection presentation, a user interface screen can be presented to the user with a list of all commercials in the commercial database. The PVR/DVR application can read the commercial database and extract the titles of all of the commercials. It can graphically display the titles to the user and allow the user to select the title for continuous viewing. For each title selected by the user, the filename, start time, and end time can be read and added to a playback list. Once all commercials have been processed in the commercial database, the PVR/DVR application can begin playing with the first commercial on the list. Playback can continue until the last frame of the last commercial in the playback list is presented.

In “all” commercials presentation, every commercial in the commercial database can be added to the playback list. In interval commercial presentation, a user interface screen can be presented to the user to allow the user to select the number commercials at a time that the user wants in a commercial continuous viewing. The PVR/DVR application can read the interval and can read the number of commercials in the commercial database. It can divide the total number of commercials into ranges and present as a list the ranges to the user for viewing. When a user selects a range, the PVR/DVR application can read the filename, start time, and end time of all commercials in the commercial database that match the range. The presentation can be the same as above.

In date range commercial presentation, a user interface screen can be provided to the user to allow the user to select a date range for searching for commercials. The commercial data base can be read and any entry that matches the date range can be added to the playback list. Once the entire database has been searched, the PVR/DVR application can read the filename, start time, and end time of all commercials in the commercial database that match the range. The presentation can be the same as above.

During the presentation of the playback list, the user can be allowed the use of trick modes to transition the continuous commercial session. Slower speeds may be enabled during commercial viewing sessions. Instead of high speed fast forward and rewind, slower speeds may be implemented because the duration of the continuous viewing session is short. Skipping at 30 seconds every frame can be prohibitive because entire commercials will be skipped during the highest of high speed fast forward and rewind. A next and previous commercial may be implemented to skip commercials in the commercial viewing session. Also a delete procedure may be added to delete individual commercials as they are being viewed in the commercial viewing session. During next and previous jumps, the PVR/DVR application can read the filename and start time of the next or previous commercial in the continuous playback list and can begin the viewing of that commercial. During a delete, the currently playing commercial can be stopped, the filename associated with that commercial can be passed to the file system to delete, the next commercial in the playback list can be read and the filename can be opened, and playback can start from the first frame of the next commercial.

Commercial Program Guide

The recording of commercials using a PVR or similar device can be made to be similar to the recording of television programs. Each commercial can be assigned a category. Because of this, the listing of recorded commercials can uniquely be displayed using a program guide layout referred to herein as a commercial guide. A category selection screen can be used to filter the list and produce a commercial guide with the requested recorded commercials. Because each commercial is typically 10 to 60 seconds in duration, hundreds or thousands of commercials can be recorded. Unique categories can be assigned to a commercial. For example: Home and Garden, Automotive, Office, Mortgage, Pet supplies, Pet Food, Local Businesses, etc., etc.

The category list can be a fixed list defined by the service provider or any other established definition for commercial categories. The service provider of the digital broadcast signal can assign a category for a commercial in the start and end synchronization packets of a commercial data stream. Alternatively, the user can categorize or re-categorize commercials as he sees fit.

Three main screens can be defined for this embodiment (but many variations are possible):
Program Guide Type Selection Screen—A new entry in the program guide type user interface can specify “Commercial Guide”.
Commercial Guide Category Selection Screen—A user interface screen can list all commercial categories.
Commercial Program Guide—An electronic program guide displaying the titles of the recorded commercials. The channel number column can be omitted, but can be included with pre-assigned channel numbers from a range of channel numbers not used by the service provider.

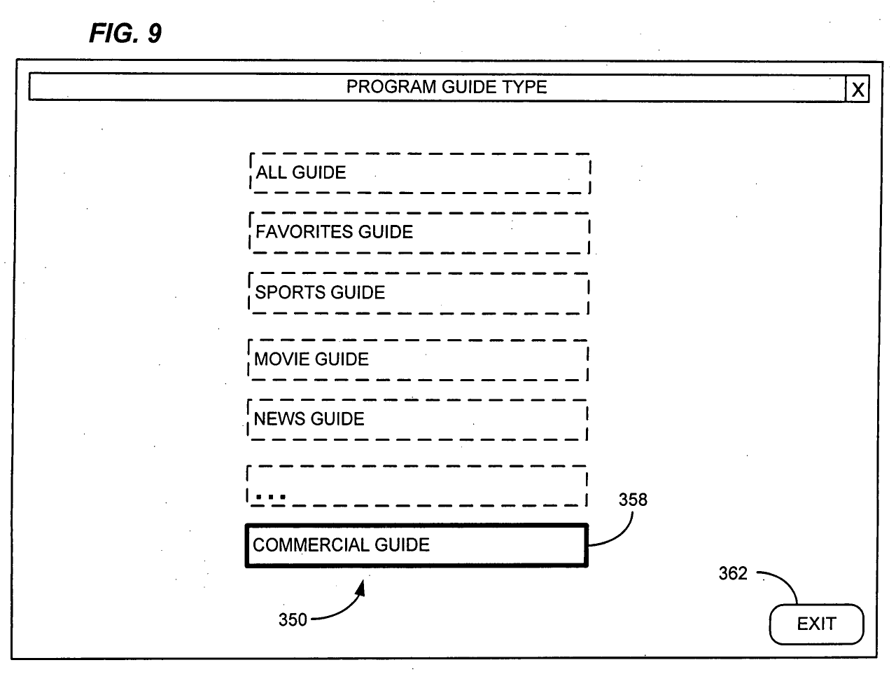

FIG. 9 depicts an exemplary user interface screen from which a user can select a program guide type to view. In this example screen, a column 350 of possible program guides is presented to the user. If more categories are available, the list can be scrolled down (or up). In this example, the commercial guide 358 is the selected type of guide. Also available are other types of program guides. When the user has made a selection the selection can be entered from the remote control in a conventional manner or the user can always exit to the previous state using button 362.

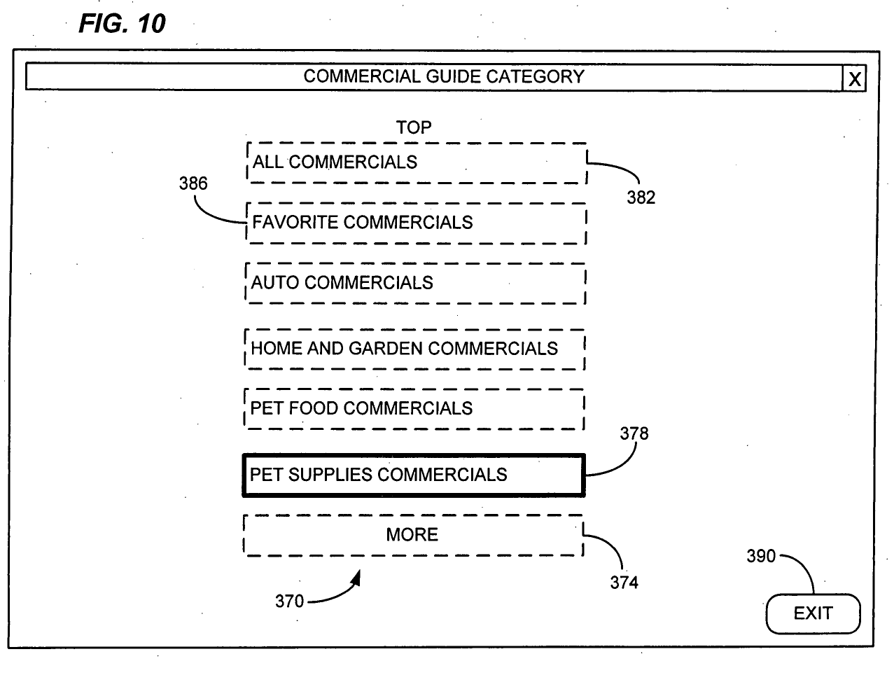

FIG. 10 depicts an exemplary user interface screen from which a user can select a commercial guide type after making the selection 358 from the prior screen. The user can select a guide to view based upon a category, all commercials or commercials categorized as a favorite. In this example screen, a column 370 of possible categories is presented to the user. If more categories are available, an indicator such as 374 can be selected to scroll down (or up). In this example, pet supplies commercials 378 is the selected category. Also available are all commercials 382 or commercials that are reclassified by the user as “favorites” 386 in a manner similar to the way favorites lists are built using program guides. Once a selection has been made it can be entered using a remote control “enter” key or the user can always exit to the previous state using button 390.

A program guide type selection screen can be made available in which a list of different types of program guide, ex, All Channel Program Guide, Favorites List Guide, etc. can be presented to the user. On this screen a new entry can be added, namely “Commercial Guide” as shown by 358. Upon selection of “Commercial Guide” by the user, the program guide type selection screen can be cleared and a “Commercial Guide Category Selection Screen” as in FIG. 10 can be rendered for the user. On this screen a list of selectable categories can be provided as defined by the service provider or any other established category list for commercials. The category list may be supplemented from the static list of categories by the service provide through any other known communication channel. The supplement can add new category entries that a service provider is supporting. The communication channel can be transport based, or internet protocol based using out-of-band channels, i.e. non-transport communication channels.

Upon selecting a category, the PVR/DVR application can search the list of commercials recorded that match the category selected. Note that upon recording a commercial, the category for the commercial can be extracted from the start or end synchronization packet of the commercial data stream, or from commercial data packets depending upon the implementation. Once a list of commercials has been found, the program guide application can render an electronic program guide for the user.

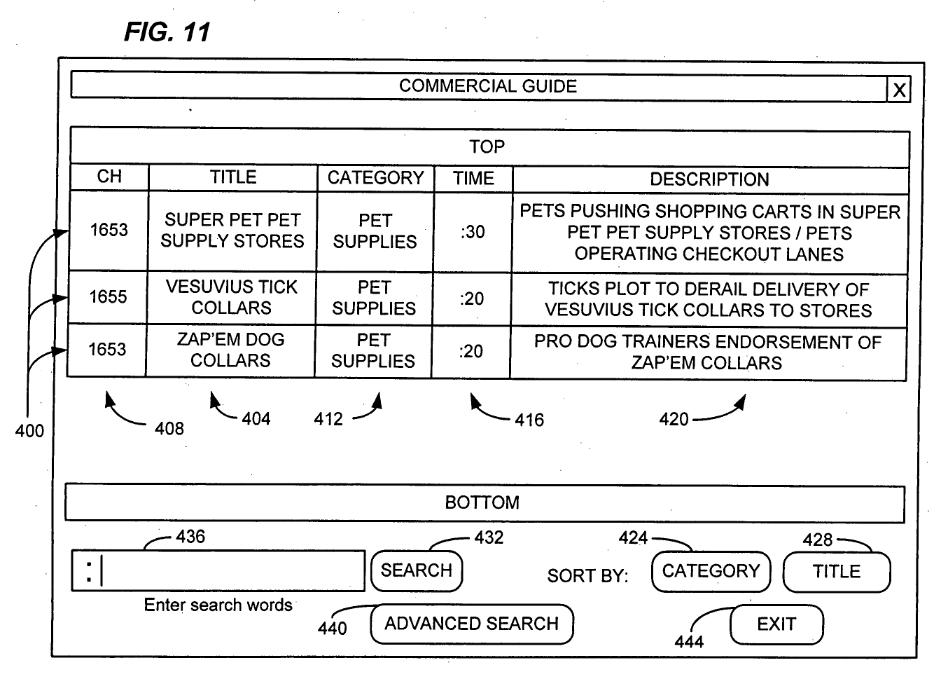

An example of such a guide screen is depicted in FIG. 11 in which the commercials are selected based upon the category “Pet Supplies”. Each commercial can occupy one row 400 in the electronic program guide. The title of the commercial (or the commercial sponsor), for example, can be displayed in the program slot column 404 of a typical program guide. A channel column 408 to the left or right can be provided with predefined channel numbers that are not defined by the service provider as any broadcast channel numbers. Other information can also be provided depending upon the implementation. For example, columns can be provided with the category such as column 412, the time duration of the commercial 416 and/or a description 420, all derived directly or indirectly from the commercial data. The program guide can be scrollable up and down. Upon selection of an entry in the program guide, the playback of that commercial can be allowed. Upon completion of the commercial, the user will be returned to the last program guide. Using a back key on the remote control can allow the user to select other categories, and so on.

An electronic program guide can be displayed with recorded commercials based on category with channel numbers corresponding to the channel number on which the commercial was recorded. The row of program entries can be a concatenated list of commercials recorded on that channel.

In certain embodiments, a search mechanism can also be provided on the commercial guide screen as depicted, while other embodiments can omit this feature in favor of dedicating more of the screen to the program guide. In this example, sortings can be done using the category 424 or title 428 sort buttons. A key word search can be carried out on the selected category using the search button 432 and text entry field 436, or the user can navigate quickly to an advanced search screen using button 440. The user can exit this screen using button 444.

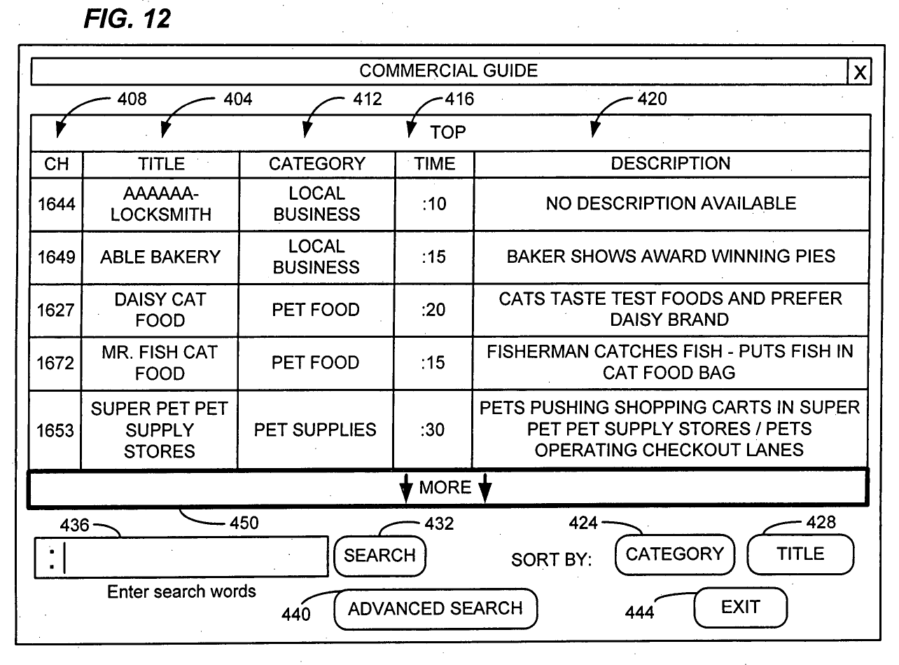

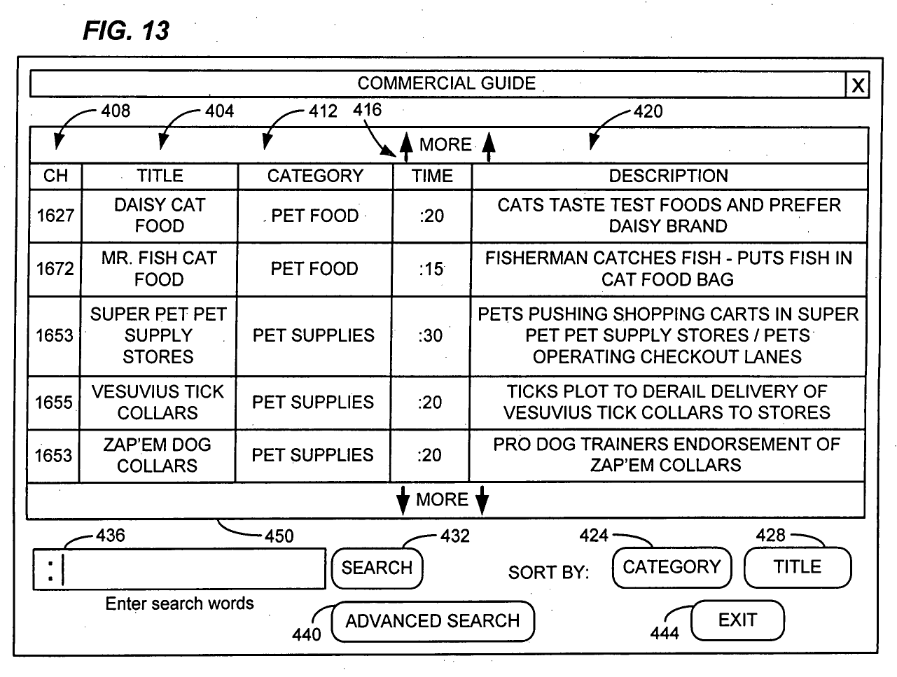

If the user selects the all commercials guide selection from the screen of FIG. 9, a listing similar to that of FIG. 11 is generated as shown in FIG. 12. In this example, the commercials are presented arranged alphabetically by category and title, but other sortings could also be used. The user can scroll downward by selecting the “MORE” bar 450 in this example to find the same categories previously identified in FIG. 11 as shown in FIG. 13.

Display of Commercial Descriptions

Currently there is no way of obtaining information about a commercial and no way of practically displaying the information. As described previously, using a commercial data stream, commercial information may be transmitted and stored by a PVR/DVR application. This information can include the commercial title, original air date, offers, such as offer codes and description information. The description information can be textual information detailing the commercial content. This description information, for example, can be approximately up to three or four lines of information describing the commercial. In certain embodiments consistent with the present invention, this description may be presented to the user in several different ways.

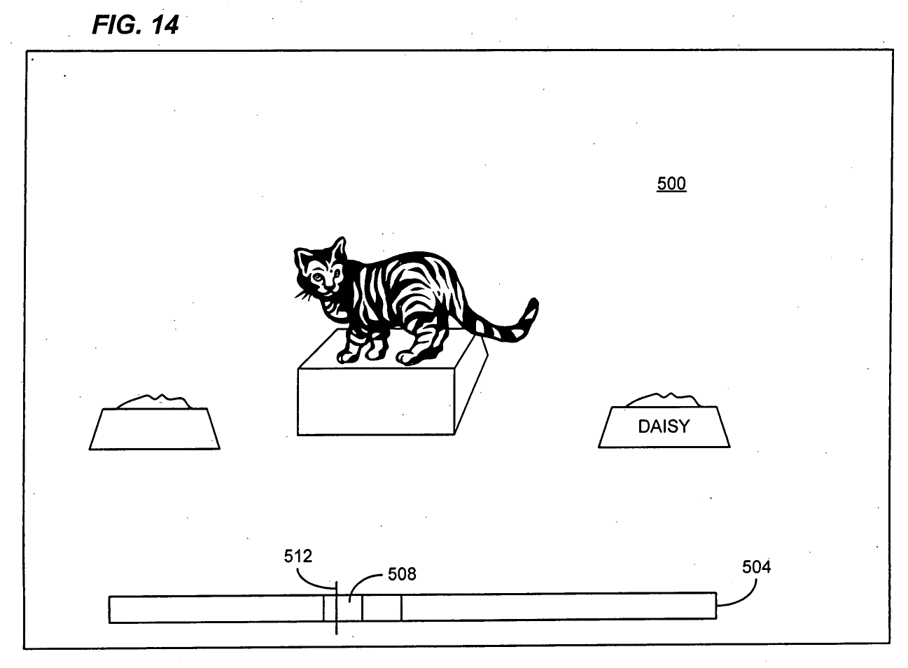

Consider, for example, a cat food commercial as depicted in FIG. 14. This commercial incorporates video and audio content with the video displayed generally in the main screen area 500. Also shown in this figure, as will be explained later, might be a progress bar 504 depicting the commercial's location 508 within a program being viewed (assuming the commercial is viewed as part of the program) with a line 512 showing the current location in time of the commercial. The progress bar will be discussed in greater detail later.

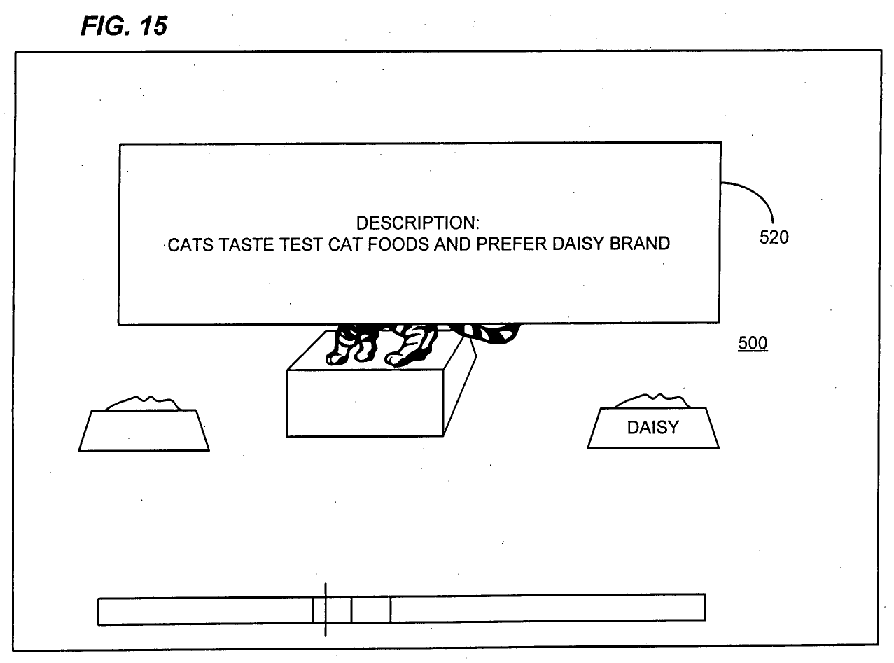

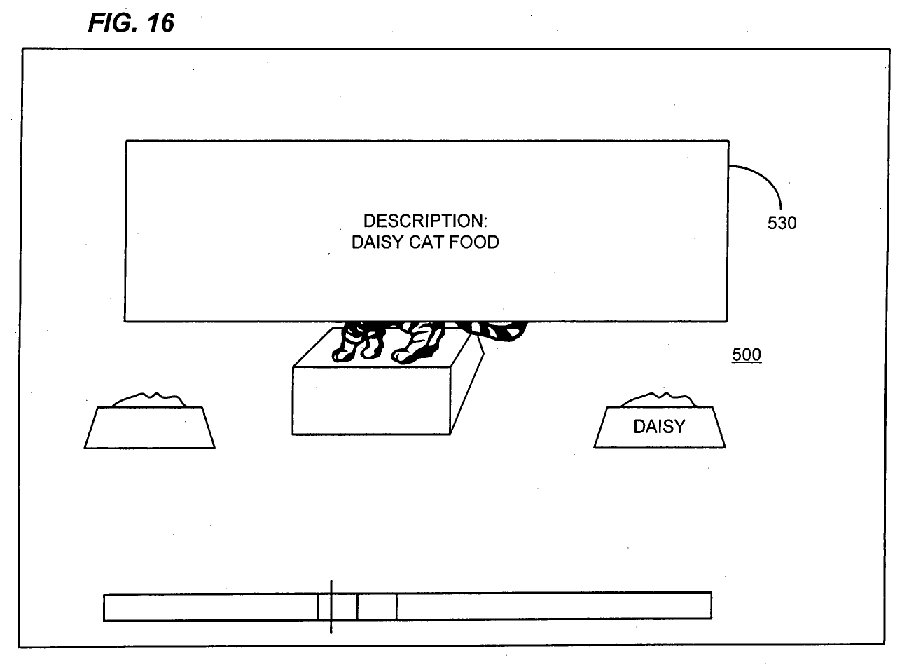

One way of presenting the description information is through a description user interface screen superimposed on the playing video commercial. In a PVR/DVR application, the description screen may contain a description of the commercial that can be access using a dedicated “display” button on the remote control. When a commercial is being played as shown in FIG. 14, the display button feature present on many television remote controls may be augmented in any number of ways to present the description information. Conventionally such buttons, when actuated, cause the display of a channel or other operational information. In certain embodiments, one way to augment use of the display button is that when no information is displayed on the screen, the first button press of the display button can display the television program description. As shown in FIG. 15, while that description is on the screen and the current commercial is playing, a second press of the display button would display the commercial description information 520. The commercial description information would replace the television's program description or other information. In other embodiments, another press of the button can reveal the commercial title, as shown in FIG. 16 as 530. In other embodiments, all available information might be displayed including time duration of the commercial and/or other information. Different information can be displayed with each actuation of the display button.

The commercial description information may be useful, because it can identify the manufacture, its contact information, offer codes, and a list of retailers selling the product, etc. Like wise, if there are commercial preview screens in the PVR/DVR application, the commercial description information may be displayed on those screens also.

During playback, the PVR/DVR application can read the stored commercial data stream and build a database of commercials for the playback. During playback, the PVR/DVR application can monitor the current playback point and compare that against the commercial database created. If the current playback point is within a commercial boundary, the display button commercial information feature can be enabled. When the user presses the display button on the remote control while the commercial is playing, the television program information can be read from the stored file and displayed for the user. When the display button is depressed again, then the television program description screen can be removed and the commercial description can be extracted from the commercial database. That information can be formatted and displayed for the user. A user may display the information for a longer period of time by pausing the playback while still in the commercial. This procedure can hold for every commercial in the recorded television program. The procedure for displaying the commercial information is, of course, not limited to this description.

Suppression of Trick Modes

One reason people enjoy use of PVR's and VTR's is for time shifting and commercial skipping. Commercial skipping may become a serious problem for broadcasters. When a user commercial skips, he or she may fast forward through commercials and not review the commercial from a recording. In this invention, using the commercial data in the transport stream, the broadcaster may set which commercials are required to be viewed during playback of a recorded program. The start/end synchronization packet or a special commercial data packet can contain a byte of data that indicates the playback requirements established or set by the broadcaster for any given commercial. The following combinations may be used, for example:
(a) Playback Every—Playback of the commercial would occur every time the program is viewed. The user may never fast forward the commercial.
(b) Playback Once—Playback of the commercial would occur once, and subsequent viewings would not prevent the user from fast forwarding the commercial.
(c) Playback None—Playback of the commercial would occur, but the viewer would not be prevented from fast forwarding through the commercial.
(d) Playback N—Playback of the commercial at least N times is required before fast forwarding through the commercial is permitted.

Thus, to minimize the consumer annoyance, the broadcaster may try to minimize the number of forced playbacks. The broadcast may sell forced playback commercial slots at a premium, but minimize the number in a television program. Playback rights for a commercial can be stored with the recorded television program. Counters are setup to indicate the number of times that the commercial has been fully viewed. Once the number of times a commercial is viewed has been satisfied, trick modes (fast forward, skip ahead) can be enabled. Note that pausing and rewinding of the commercial can be allowed. A commercial is viewed when all frames for the commercial have been rendered to the user during playback. Live recording can follow the same rules as the settings in the start/end synchronization packets, but the viewing during live of these commercials can not count towards the interval of viewing requirements of commercials. An icon can be used to indicate that trick modes are disabled during forced commercial playback. For example the icon may read, “Sponsor”.

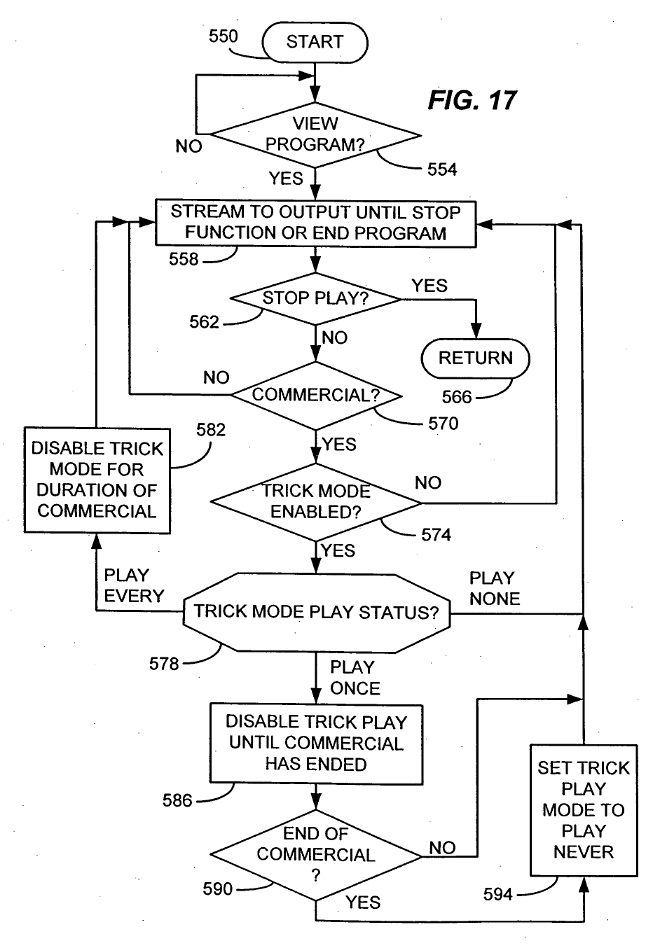

In accordance with one embodiment, as shown in the flow chart of FIG. 17 starting at 550, the PVR/DVR application can store the Commercial Data Stream as Meta-Data with the recorded audio/video content. When a user decides to view a program at 554, the PVR/DVR begins sending the program stream to the output until a stop command is encountered or the end of the program is reached at 558. If a stop command is received from the user at 562, the process returns at 566. During Live playback, the PVR/DVR application can read the stored commercial data in the transport data stream. When a commercial is encountered at 570, a PVR/DVR application processes the start/end synchronization packet of the commercial data stream, the commercial playback type can be read (either from the start/end synchronization packet or from the commercial data packet, depending upon the embodiment).

If trick mode has not been enabled at 574, control returns to 558 where the stream of output data continues. If trick mode is enabled (before or any time during the play of the commercial, control passes to 578 where the trick mode status is inspected. If playback every (or playback always) is indicated for a commercial at 578, control passes to 582 where certain trick modes such as fast forward trick modes are disabled for the viewing, thus requiring the user to view the commercial. If the user was already fast forwarding, the fast forward trick mode is halted at 582 and playback can be synchronized to the beginning of the commercials. The fast forward trick mode remains disabled until the entire commercial is viewed. If a user is skipping past a commercial, the skip can be canceled and the playback is synchronized to the beginning of the commercial. During live record playback rewind, the user can be able to rewind through the commercial, but if the user rewinds past the beginning of the commercial, the commercial plays in it's entirety during playback.

If playback once is indicated at 578 for a commercial, forward trick modes can be disabled at 586 in much the same manner as in 582 for the viewing. As in the playback every case, fast forward and skip ahead can be disabled and the viewer is required to play the entire commercial at normal playback speed. Once the commercial has been viewed at least once and the end of the commercial is reached at 590, a temporary flag can be set to indicate that any subsequent trick mode maneuvers through this commercial can be enabled. Note that this flag can be reset after the live recording completes, thus during playback of a completely recorded television program, commercial playback can following recorded commercial data stream rules. During playback of a completely recorded television program, the same rules apply as in the live record. The only difference is that when a playback once commercial has been viewed, a permanent flag is set in the meta-data of the recorded program for that commercial. This is equivalent to setting the trick play mode to play never as indicated in 594 Thus, at any time in the future, if the user is viewing the television program, that commercial may be fast forwarded.

Optionally, every time the PVR/DVR application is required to playback a commercial, an icon may be displayed on the television screen indicating that the current commercial may not be skipped. The type or label for the icon is not defined, but something like “Sponsor” may be displayed for the user to indicate that the user may fast forward through a commercial if that icon is not displayed.

If the play none mode is indicated at 578, the program stream plays normally without any prohibition against use of any trick play mode.

Commercial Progress Bar

In certain current PVR/DVR applications, a progress bar is rendered for a user to indicate how much of a recording has been recorded and the current playback position. However, known implementations do not indicate any other information about the program. In accordance with certain embodiments consistent with the present invention, using a commercial data stream, the progress bar may be augmented by colorizing the portion of the progress bar that represents a commercial. Using the progress indicator, the user can see visually when a commercial is about to begin. A vertical separator may be used to show the boundaries of the commercials in the playback. The user can the count visually the number of commercial in any one break. The progress bar also may show all of the commercials in a recorded television program. Thus, the user can see how much of the recording is commercials verse the actual television program.

Using the commercial trick mode suppression technique, an icon at the location on the progress bar of a commercial that is trick mode suppressed can be displayed allowing the user to see which commercials they cannot skip. This is a useful tool for users when they need to plan different activities during a viewing of a recording.

A commercial data stream as described above can be transmitted by the service provider indicating the location of commercials in a transport stream. Any suitable interface can be utilized, for example, hitting the play button on the remote may bring up a progress bar for the current playback. Upon depressing the button sequence to bring up a progress bar, the PVR/DVR application can read the start time, end time, and current playback time for the current playback. The PVR/DVR application can read the stored commercial data stream from the stored file. In the case of live recordings, the commercial data stream may be cached in memory. In either case, for each commercial for the current duration of the progress bar, the start time and end time can be stored in a commercial progress bar database. The times between commercials can be assumed to be part of the television program. The progress bar segments can be reported to the user interface application as a list containing, for example:
Start Time—start time can be a relative time. For example, number of seconds from current time or end time. This is to aid in the construction of the progress bar by the user interface application. But, the start time can be of any configuration or type.
End Time—just like the start time, the end time can be a relative time from the current time or end time.
Segment Type—Television program segment or commercial segment.

This list of segments is rendered by the user interface. Note that each commercial in the recording is a separate entry in the list. Color one can be used for television program segments and color two may be used for commercial segments. A vertical separator can be used to provide a cleaner transition between colors of the television program segments and the commercial segments. For those commercials that are trick mode inhibited, an icon can be displayed, or a different color, perhaps color three, can be used to indicate those commercials that trick modes can not be used during playback. The progress indicator is relative to the global start time and end time, thus its location is scaled based on the global settings and is not effected by a list of segments.

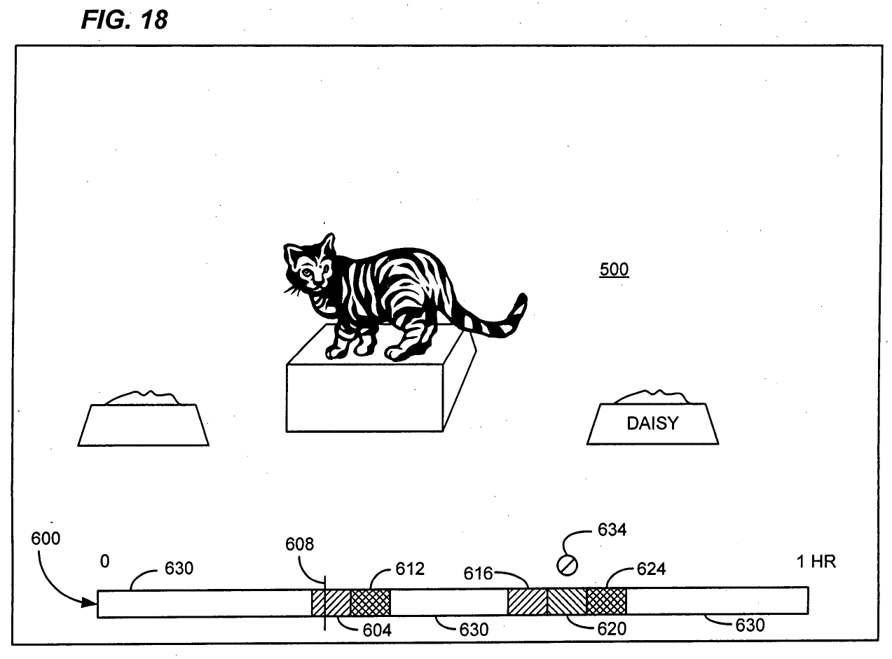

An exemplary embodiment of the progress indicator is depicted in FIG. 18 with the commercial video content 500 again occupying the major portion of the display screen. The progress indicator bar 600 indicates that commercial segment 604 is being viewed and the vertical line 608 is indicative graphically of the progress point in time corresponding to the playback of the commercial 604. As the commercial progresses, line 608 moves from left to right to show progress. Commercials 612, 616, 620 and 624 are rendered in different colors than the color used to render segments of the television program itself 630. An icon such as 634 indicates that commercial 620 has restrictions on use of trick modes. Additionally, or alternatively, the color of the rendering of the color of the bar segment representing commercial 620 can be indicative of such restrictions. The progress bar may also include time indications at one or both ends of the bar to show the relative time scale.

Magnified Progress Bar

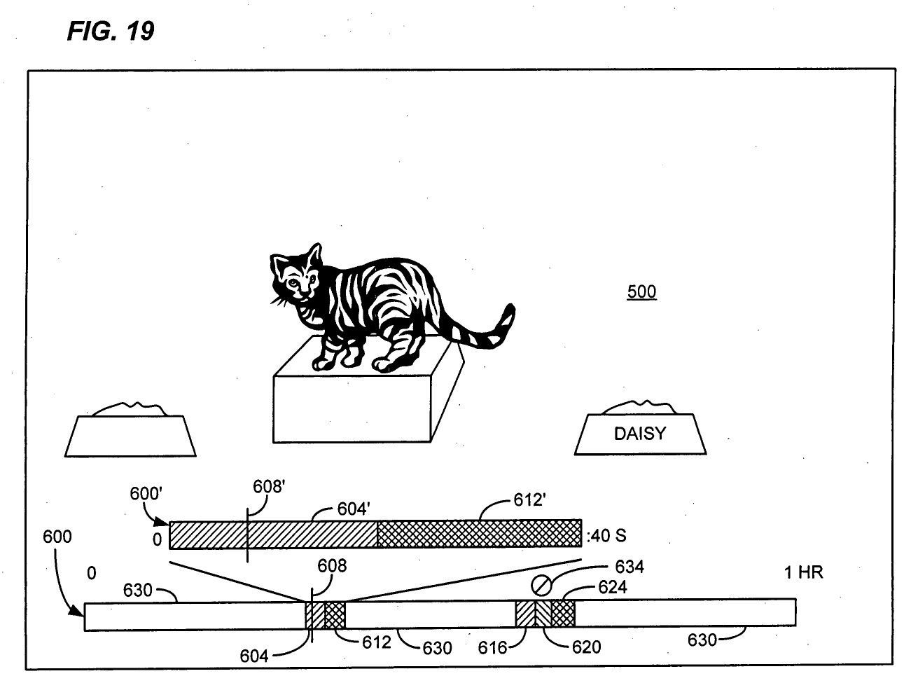

Commercials durations are typically small, on the order of 30 seconds. In any one commercial segment there may be 3 or 4 commercials with a cumulative duration of 2 minutes or so. Using a commercial color progress bar as described above, the commercials may only show up as thin lines if a recorded program was long in duration (e.g., 2 hours in duration). To aid the user, a magnifying progress bar can be implemented as depicted in FIG. 19. When a user is viewing a commercial and displays the progress bar, a normal progress bar 600 as previously described can be rendered, and another progress bar may be rendered above (or superimposed, or using another visually appealing arrangement) that shows a magnified portion of the commercial segment. The commercial segment may contain several commercials that appear consecutively. Thus the unmagnified progress bar can show a thin vertical line or narrow bar as depicted in FIG. 19 showing the location of the commercials, but the second progress bar shows an expanded version of the commercial segment. The expanded progress bar can have specific time stamps above it or next to it as shown. It can also have titles printed in the progress bar, etc.

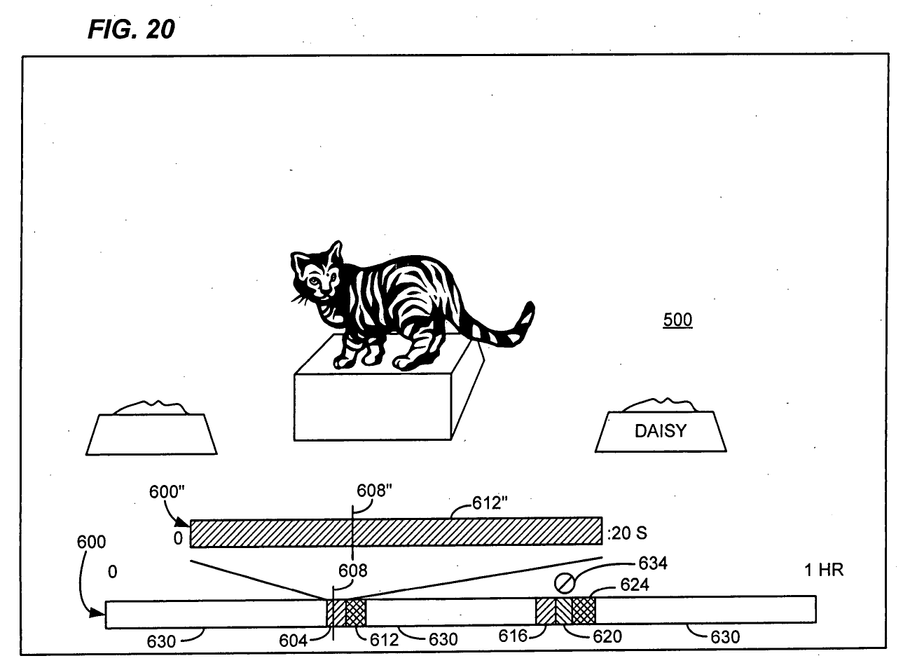

As shown in FIG. 19, commercials 604 and 612 are expanded in the magnified progress bar 600′ and shown as 604′ and 612′ with the vertical indicator line 608 shown in the magnified progress bar as 608′. Referring to FIG. 20, in another embodiment the magnified progress bar shown as 600″ may represent only a single commercial 612″ that is currently being played out. Again, a vertical progress indicator 608″ moves toward the right to indicate the relative progress of the commercial. As soon as the last frame of the last commercial in that segment is played, the magnified progress bar can be turned off leaving only progress bar 600.

The magnified progress bar can be implemented by use of the commercial data stream to determine the commercial segment locations and other commercial information. Any suitable interface can be used to access the magnified progress bar. Upon accessing the progress bar, the PVR/DVR application can read the commercial data stream and build a database of commercials. The database can contain the start and end times of the commercial, the title, and information.

The PVR/DVR application can read the current location of the progress indicator. If the progress indicator is within a program segment, the magnified progress bar can be disabled. If the progress indicator is within a commercial, the PVR/DVR can build a list of commercials in that list. The start time and end times can be concatenated to form a start time and end time of the magnified progress bar. The user interface can render the progress bar on the television screen in a location chosen arbitrarily or as selected by the user or designer. The colors of the magnified progress bar can follow the colors from the main progress bar. The magnified progress bar can also be implemented such that the magnified progress bar may be enabled a few minutes before a commercial segment and for a few minutes after the commercial segment, thus the magnified commercial progress bar may contain both all of the commercials in that commercial segment and a portion of the television program before the commercial and after the commercial. The magnified commercial progress bar can delineate each of the commercials. If room permits, the title of each commercial may be displayed right on the progress bar. Special icons can also be displayed to indicate sponsored commercials or commercials with trick mode restrictions.

Reordering Commercials

Since commercials are an annoyance to some people, automatically skipping commercial would be a preferred mode of operation for these consumers. However, this is an undesirable scenario for a broadcaster. In certain embodiments consistent with the present invention, a compromise may be provided. Broadcasters want to suppress viewers from fast forwarding through commercials, and consumers don't want to deal with them. Thus, by using the commercial data stream, commercials may be extracted from a broadcast television program and played at a different time. For example, if a two hour movie contains 20 commercials, those 20 commercials may be extracted and played before the movie starts, after the movie ends or in the middle of the movie to create an artificial intermission. Using the commercial trick mode suppression technique, selected commercials may be played with trick modes turned off, so the user is forced to watch the commercial at the beginning. The remaining commercials may have trick modes enabled, so it is at the user's discretion to watch the commercial.

The playing of commercials can be rearranged in any suitable manner. For example, several non-trick mode commercials may be played at the beginning and several at the halfway point. In any case, commercials that are duplicates during a movie may be suppressed and only one version played back, and commercials that have been moved don't have to be played in their original time slot. During the time that a commercial is removed, a transition filter may be applied to make the stream look continuous. Just before a commercial is about to start, a fade transition may applied to go to black, and a fade in filter may bring in the next segment. This is to prevent an abrupt change of scenes. Another flag in the commercial data packet or start/end synchronization packet may be added to indicate the preferred playback time during a recorded television program playback.

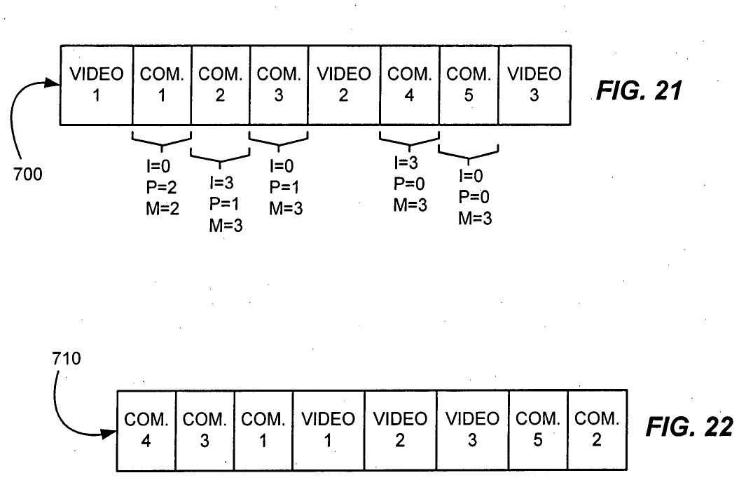

The commercial data packet or start/end synchronization packet can include a commercial position flag that indicates the preferred position of the commercial playback. In one embodiment, as illustrated by stream 700 of FIG. 21, this flag can be made up of three bits of information as follows:
Commercial Priority (P)—Defines an integral number that sets the priority of a commercial at any interval. The highest priority commercial can be played first for a commercial interval. If multiple commercials have the same priority, their order is arbitrary.
Commercial Interval (I)—Defines an integral number for which interval that this commercial belongs in. A commercial interval is defined by the original playback positions of commercials. Commercial interval equal to zero indicates that the commercial should be played before the movie starts. When the original commercials are aired, each commercial group is a commercial interval, thus the first group of commercials after the movie has started in the original broadcast is a commercial interval equal to one.
Commercial Interval Max (M)—Defines an integral number signifying the maximum intervals for a television recording. Thus, the commercial interval above may be reference correctly. If this value was not here, and commercial intervals were not recorded, all remaining intervals may be played back towards the end of the recorded movie.

In stream 700, commercial 1, for example, has I=0, P=2 and M=2. In a similar manner, commercials 2, 3, 4 and 5 are shown with values of I, P and M.

When a program is selected for playback, the PVR/DVR application can read the commercial data stream stored as meta-data from the playback file. It can make a database of all commercials available during that playback. It can delete any duplicate commercials based on the commercial identifier. The PVR/DVR application can sort the data base based on commercial interval and then commercial priority at that commercial interval. If any entries in the playback database have a commercial interval equal to zero, those commercials can start to play in the order of the commercial priorities. For those commercials that have trick modes suppressed, trick modes can not be active during that time. For each commercial, the playback position is read from the database.

The PVR/DVR application can position the playback position at the first frame of the commercial to playback. Playback can continue until the last frame of that commercial is rendered. If any other commercials are to be displayed during that commercial interval, the same procedure for each commercial can be performed. When the last frame of the last commercial for a commercial interval is rendered, the first frame of the next video interval is started. Playback continues until the last frame of that video interval. The commercial playback database is checked for the next commercial interval. If there are any commercials to play during that time, playback position is set to the first frame of that commercial, and so on. During trick modes, if the user is fast forwarding past the end of a commercial, if allowed, the playback position jumps to the appropriate frame to display for the fast forward speed of the next commercial. Fast forward transitions to video intervals translate to frame offsets into that video interval. Thus to the user, the video stream looks continuous no matter where the commercial is played. The same is true for rewind. During slow motion, the transition filters can fade in and out allowing smooth slow motion. The transition filters can be applied only for discontinuous playback positions.

Thus, after processing by the PVR/DVR application, the stream 700 can be rearranged to present a new ordering of the commercials and video stream as shown by stream 710 in FIG. 22. In this example, commercials 4, 3 an 1 are moved to the beginning and commercials 5 and 2 are moved to the end. This repositioning permits continuous uninterrupted viewing of the video segments 1, 2 and 3.

In accordance with certain embodiments, the ordering of the commercials can be carried out in an number of ways. In one embodiment, the user can individually rearrange the order on a case by case basis as permitted by the commercial position flag. In other embodiments, the commercials can be automatically rearranged according to a pre-programmed algorithm. In other embodiments, the user can establish preferences that help define an algorithm that is then used to rearrange the commercials. Other variations will occur to those skilled in the art upon consideration of the present teaching.

Display of Commercial List

While restrictions on use of trick modes may be beneficial to broadcasters, viewing commercials during recorded television program playback can be annoying to a user, when the service provider forces a user to view a commercial by disabling trick modes. In accordance with certain embodiments consistent with the present invention, a method for providing a user a choice of viewing any commercial in the recorded television program can be provided. The commercial data stream may be further augmented to provide a new packet type of commercial presentation packet. In other embodiments, the information can simply be added to the commercial data packet(s) or to the start/end synchronization packets. This packet type can provide data that will indicate to the PVR/DVR set-top-box when a user is required to view commercials during a television recording playback. The commercial presentation packet can contain the following:
Packet Type—fixed to commercial presentation.
Max Segments—maximum number of commercial segments in television program.
Segment List—list of segments.
Segment Start Time—real time stamp of when the commercial segment starts.
Segment End Time—real time stamp of when the commercial segment ends.
Segment Viewing Requirements—segment requirements.
Required Commercials—the number of required commercials during this segment.
Required Count—the number of times required to be viewed, i.e. each time that a commercial is viewed during this segment, the internal count decrements until no commercials are required during this segment. If a user views the recording more than once, eventually the viewing can be without commercials.

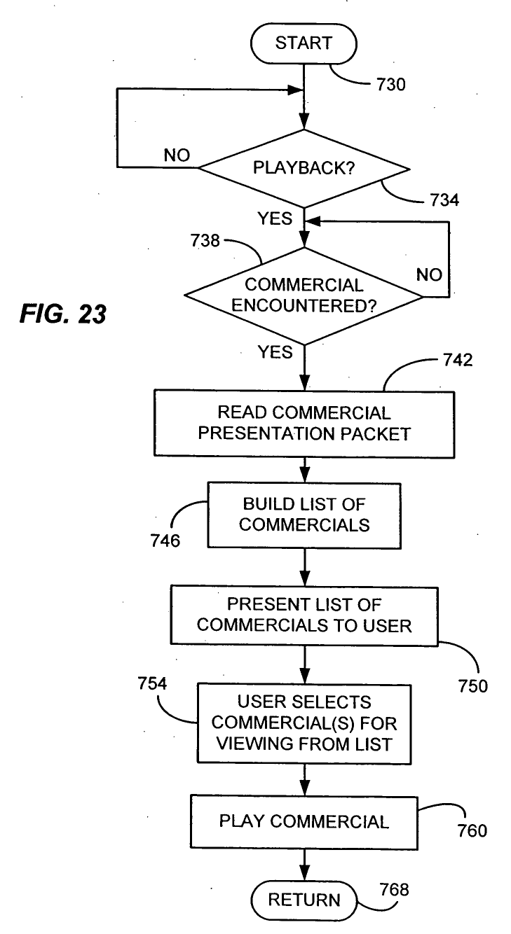

By reading the information from the commercial presentation packet of the commercial data stream, the PVR/DVR set-top-box can present a user interface at the playback point representing a commercial segment in the commercial presentation packet in a manner as described, in one exemplary embodiment, by the flow chart of FIG. 23, starting at 730. If the user is viewing a program at 734 and the commercial segment start time occurs at 738, the commercial presentation packet is read at 742 and a list of commercials is built or retrieved at 746. A user interface screen can be presented at 750 to ask the user to pick a commercial to view. A list of all of the commercials in the recording can be displayed for the user. When the viewer chooses the commercial to view at 754 from the list, the commercial can start playing at 760 until it is entirely rendered. The process returns at 768. All fast forward trick modes can be disabled during that time.

Once the commercial is viewed, the television program can continue playing with the next segment. In this embodiment, a user can select any number of commercials to view during this time. The number of forced playback segments can be controlled by the service provider. A global setting may be established to disable this feature, thus during normal playback commercials would play in their original broadcast time slot, and those commercials that are trick mode disable can play in their entirety before continuing.

The PVR/DVR set-top-box can store the commercial data stream as part of the recording of a television program as meta-data in the record file. A setup screen can be provided as part of the set-top-box setup sequence to allow the enabling or disabling of this invention feature. When enabled, a user must start the viewing of a recorded television program by choosing the recording from a list of recording.

When a program starts to be viewed, the PVR/DVR application can read the stored commercial data stream. It can extract the commercial presentation packet and parse it to produce a database of segments and segment requirements. When a user is viewing a program, or using trick modes to move within a recording, the PVR/DVR application can monitor the current display time. If the current display time is within the commercial segment time boundary, the playback can pause. The PVR/DVR application can create a user interface screen listing all of the commercials in the current recorded television program. It can read the commercial data stream start/end synchronization packets to build a database of commercials in this recording.

The titles of all of the commercials can be extracted and presented to the user. The user then can be able to choose at least one commercial for viewing, but may select all for viewing. When the selection is complete, all of the commercials can play in the order of the selected list. For each commercial, the commercial data packet or the start/end synchronization packet can be read to get the start and end time of the commercial in the recording. Once all of the frames of a recording are rendered, either the next commercial can be played, or playback from the start of the next television program can begin.

For those commercial segments that no commercials are required, those commercials can be skipped and playback may continue with the next frame of the next television segment. A flag indicating how many commercials were viewed for a commercial segment can be stored in the file of the recorded television program. This flag can then be used to compare against the Required Count indicator of the commercial presentation packet for a particular commercial segment. The flag increments every time a commercial is viewed. Once the required count is satisfied, the commercials during that commercial segment may be skipped all together.

Example PVR/DVR Hardware

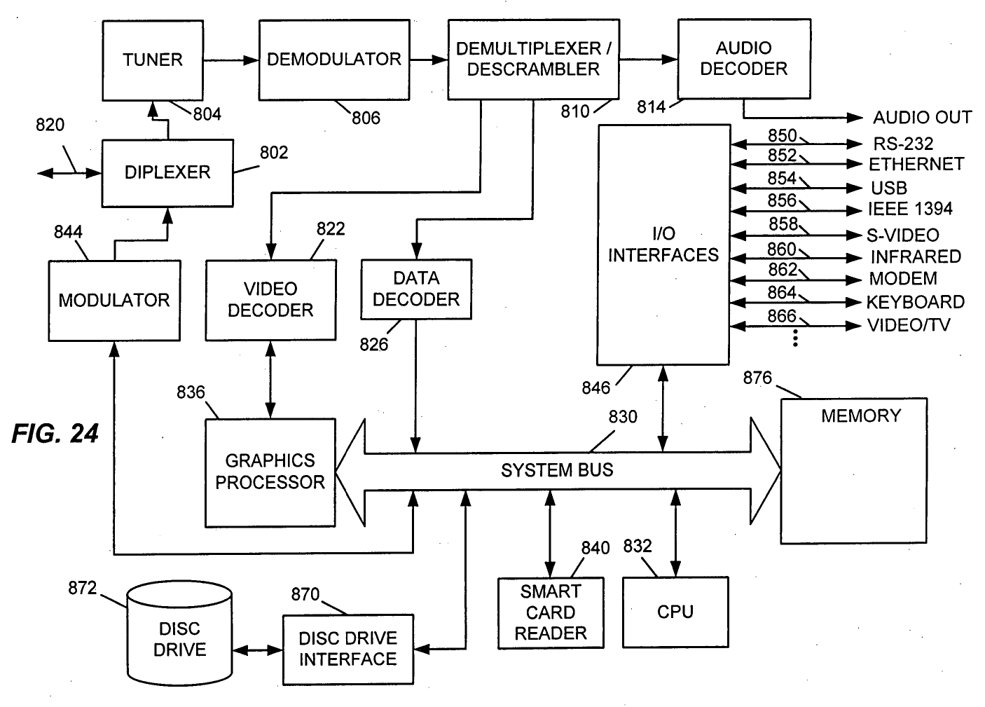

Embodiments consistent with the present invention can be carried our in a PVR/DVR type device similar to that depicted in FIG. 24. In this exemplary set-top box PVR/DVR arrangement, the transmission medium 820, such as a coaxial cable, is coupled by a suitable interface through a diplexer 802 to a tuner 804. Tuner 804 may, for example, include a broadcast in-band tuner for receiving content, an out-of-band (OOB) tuner for receiving data transmissions. A return path through diplexer 802 provides an OOB return path for outbound data (destined for example for the head end). A separate tuner (not shown) may be provided to receive conventional RF broadcast television channels. Modulated information formatted, for example, as MPEG-2 information is then demodulated at a demodulator 806. The demodulated information at the output of demodulator 806 is provided to a demultiplexer and descrambler circuit 810 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 810 also decrypts encrypted information in accordance with a decryption algorithm to prevent unauthorized access to programming content, for example.

Audio packets from the demultiplexer 810 (those identified with an audio PID) are decrypted and forwarded to an audio decoder 814 where they may be converted to analog audio to drive an audio system (e.g., stereo or home theater multiple channel audio systems). Video packets from the demultiplexer 810 (those identified with a video PID) are decrypted and forwarded to a video decoder 822. In a similar manner, data packets from the demultiplexer 810 (those identified with a data PID) are decrypted and forwarded to a data decoder 826.

Decoded data packets from data decoder 826 are sent to the set-top box PVR's computer system via the system bus 830. A central processing unit (CPU) 832 can thus access the decoded data from data decoder 826 via the system bus 830. Video data decoded by video decoder 822 is passed to a graphics processor 836, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 832 in some applications where the decoded video is passed directly from the demultiplexer 810 to a video encoder. Graphics processor 136 is also coupled to the system bus 830 and operates under the control of CPU 832. The processes described herein can be carried out using computer programs running on CPU 132.

Many set-top boxe PVR's may incorporate a smart card reader 840 for communicating with a so called “smart card”, often serving as a Conditional Access Module (CAM). Others may not use such a CAM. The CAM may include a central processor unit (CPU) of its own along with associated RAM and ROM memory. Smart card reader 840 is used to couple the system bus of the PVR/DVR to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

This exemplary PVR can operate in a bidirectional communication mode so that data and other information can be transmitted not only from the system's head end to the end user, or from a service provider to the end user, but also, from the end user upstream using an out-of-band channel. In one embodiment, such data passes through the system bus 830 to a modulator 844 through the diplexer 802 and out through the transmission medium 820. This capability is used to provide a mechanism for the PVR/DVR STB and/or its user to send information to the head end (e.g., service requests or changes, registration information, etc.) as well as to provide fast outbound communication with the Internet or other services provided at the head end to the end user.

The PVR/DVR may include any of a plurality of I/O (Input/Output) interfaces represented by I/O interfaces 846 that permit interconnection of I/O devices. By way of example, and not limitation, a serial RS-232 port 850 can be provided to enable interconnection to any suitable serial device. Similarly, communication with appropriately compatible devices can be provided via an Ethernet port 852, a USB (Universal Serial Bus) port 854, an IEEE 1394 (so-called firewire™ or i-link™) or IEEE 1394 wide port 856, S-video port 858 or infrared port 860. Such interfaces can be utilized to interconnect the PVR/DVR with any of a variety of accessory devices such as storage devices, audio/visual devices, gaming devices, Internet Appliances, etc.

I/O interfaces 846 can include a modem (be it dial-up, cable, DSL or other technology modem) having a modem port 862 to facilitate high speed or alternative access to the Internet or other data communication functions. In one preferred embodiment, modem port 862 is that of a DOCSIS (Data Over Cable System Interface Specification) cable modem to facilitate high speed network access over a cable system, and port 862 is appropriately coupled to the transmission medium 820 embodied as a coaxial cable. Thus, the PVR/DVR can carry out bidirectional communication via the DOCSIS cable modem with the PVR/DVR being identified by a unique IP address. The DOCSIS specification is publicly available.

A PS/2 or other keyboard/mouse/joystick interface such as 864 can be provided to permit ease of data entry to the PVR/DVR. Such inputs provide the user with the ability to easily enter data and/or navigate using pointing devices. Pointing devices such as a mouse or joystick may be used in gaming applications.

Of course, the PVR/DVR also may incorporate basic video outputs 866 that can be used for direct connection to a television set instead of (or in addition to) an IEEE 1394. In one embodiment, Video output 866 can provide composite video formatted as NTSC (National Television System Committee) video. In some embodiments, the video output 866 can be provided by a direct connection to the graphics processor 836 or the demultiplexer/descrambler 810 rather than passing through the system bus 830 as illustrated in the exemplary block diagram. S-Video signals from output 858 can be similarly provided without passing through the system bus 830 if desired in other embodiments.

A disc drive 872 is coupled to the system bus 830 via disc drive interface 870 and serves as a storage medium for the recorded television commercials discussed herein. Such commercials can be stored in a designated folder of disc drive 872 as previously discussed. Moreover, the database discussed can be stored on disc drive 872. The processes described above can be carried out by execution of computer programs running on CPU 832 with the programs stored in memory 876.

This embodiment is intended to be purely illustrative of one PVR/DVR type device, and should in no way be considered limiting on the various embodiments consistent with the invention.

Thus, in accordance with certain embodiments consistent with the present invention, a method of commercial storage might involve receiving a transport stream containing commercial video and commercial data; determining a starting and ending point for the commercial video; and storing the commercial video to a storage location of a storage medium designated for storage of commercials.

In accordance with certain embodiments consistent with the present invention, a method of commercial play involves identifying a commercial video for play; retrieving the commercial video stored in a commercial video storage location of a disc drive; and sending the commercial video to a display device.

In accordance with certain embodiments consistent with the present invention, a computer readable video signal includes a video transport stream carrying a stream of video representing a commercial; a commercial start synchronization packet that establishes a starting time for the commercial; and commercial description data that provides descriptive information about the commercial.

In accordance with certain embodiments consistent with the present invention, a method of commercial storage involves receiving a transport stream containing commercial video and commercial data; comparing information in the commercial data to an established criterion; and if information in the commercial data meets the established criterion, storing the commercial video to a storage location of a storage medium designated for storage of commercials.

In accordance with certain embodiments consistent with the present invention, a method of commercial storage involves receiving a transport stream containing commercial video and commercial data; reading the commercial data from the transport stream; and storing at least a portion of the commercial data to a database.

A computer readable database arrangement for storing information relating to commercials, consistent with certain embodiments has a code segment for reading commercial data from a transport stream; a database field for storing a commercial identifier; a database field for storing a commercial category; and a database field for storing a commercial description.

In accordance with certain embodiments consistent with the present invention, a method of commercial play involves retrieving data from a commercial database to identifying a commercial video for play; retrieving the commercial video stored in a commercial video storage location of a disc drive; and sending the commercial video to a display device.

In accordance with certain embodiments consistent with the present invention, a method A method of commercial play involves identifying one or more commercials for continuous play; build a list of the one or more commercials for continuous play; endlessly retrieving the commercial video associated with the commercials from the list; and sending the commercial video to a display device.

In accordance with certain embodiments consistent with the present invention, a method of commercial play involves identifying a plurality of commercials having a designated playback position within a recorded television program; modifying the designated playback position of at least one of the commercials within the recorded television program to produce a modified playback position; retrieving the television program including the plurality of commercials from a storage location; and sending the television program to a display device with the commercials positioned in the modified playback position.

A computer readable video signal consistent with certain embodiments has a video transport stream carrying a stream of video representing a commercial; a commercial start synchronization packet that establishes a starting time for the commercial; and commercial description data that provides descriptive information about the commercial, wherein the commercial data comprises at least one of a commercial priority, a commercial interval, a maximum commercial interval, and trick mode control data.

A program guide for television commercials consistent with certain embodiments has a mechanism for presenting a user interface screen, the user interface screen having a grid displaying available television commercials for viewing, wherein the grid is arranged in rows and columns, with each row representing a television commercial and with each column representing an attribute of the television commercial for the column. A mechanism is provided for navigating a cursor mechanism about the user interface screen. A mechanism is provided for selecting a commercial for play.

In accordance with certain embodiments consistent with the present invention, a method of displaying a commercial involves playing a segment of recorded video containing a plurality of commercials; presenting a menu of available commercials;
receiving a selection from a user interface of a commercial selected from the plurality of commercials; and playing the selected commercial.

In accordance with certain embodiments consistent with the present invention, a method of displaying a commercial description involves receiving a user command to display a commercial description; retrieving a commercial description stored in a computer file; establishing a window on a display that covers a portion of the display; and presenting the retrieved description within the window.

An apparatus for displaying a commercial description consistent with certain embodiments has a receiver for receiving a user command to display a commercial description. A computer file stores commercial descriptions. A commercial description stored in the computer file can be retrieved. A window is established on a display that covers a portion of the display, and the retrieved description is presented within the window.

In accordance with certain embodiments consistent with the present invention, a method of commercial storage involves receiving a transport stream containing commercial video and commercial data, wherein the commercial data comprises trick mode control data; reading the trick mode control data; storing the trick mode control data; and storing the commercial video to a storage location of a storage medium designated for storage of commercials.

In accordance with certain embodiments consistent with the present invention, a method of commercial play involves reading trick mode control data from a computer file associated with a commercial; determining if trick mode play is prohibited for the commercial; retrieving the commercial stored in a commercial storage location of a disc drive; if trick play is not permitted for the commercial, disabling the prohibited trick modes during play of the commercial; and sending the commercial video to a display device.

A computer readable video signal consistent with certain embodiments has a video transport stream carrying a stream of video representing a commercial; and a trick play control data segment that determines the user's ability to use trick play modes during the commercial.

In accordance with certain embodiments consistent with the present invention, a method of displaying a commercial involves retrieving data representing timing of a commercial; playing the television commercial for display on a display screen; and generating a graphical representation of the progress of playing the commercial, wherein the graphical representation provides a visual indication of the amount of time the commercial occupies and has an indicator that moves to designate the current time in relation to the total time occupied by the commercial.

In accordance with certain embodiments consistent with the present invention, a method of displaying a commercial involves retrieving data representing timing of a commercial; playing the television commercial for display on a display screen; generating a first graphical representation of the progress of playing the commercial, wherein the graphical representation provides a visual indication of the amount of time the commercial occupies and has an indicator that moves to designate the current time in relation to the total time occupied by the commercial; and generating a second graphical representation of the commercial, wherein the second graphical representation provides a visual indication of the location of the commercial within the surrounding programming.

Those skilled in the art will recognize, upon consideration of the above teachings, that certain of the above exemplary embodiments are based upon use of a programmed processor such as computer 832. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor such as 832 executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A program guide for television commercials, comprising:
means for presenting a user interface screen, the user interface screen having a grid displaying available television commercials for viewing, wherein the grid is arranged in rows and columns, with each row representing a television commercial and with each column representing an attribute of the television commercial for the column;
means for navigating a cursor mechanism about the user interface screen; and
means for selecting a commercial for play.

2. The commercial guide according to claim 1, wherein the attributes of the television commercial are obtained from a commercial database.

3. The commercial guide according to claim 2, wherein the commercial data is derived from commercial data forming part of a transport stream and stored in the commercial database.

4. The commercial guide according to claim 1, wherein the commercials are stored on a disc drive.

5. The commercial guide according to claim 1, wherein the commercial attributes comprise at least one of a commercial title, a commercial category, a commercial start time, a commercial end time, a commercial duration, a key word, a commercial identifier, a commercial sponsor, an offer associated with the commercial, and a commercial description.

6. The commercial guide according to claim 1, further comprising means for navigating to the commercial guide, and wherein the commercial guide comprises one of a plurality of program guides available for selection.

7. The commercial guide according to claim 1, further comprising means for designating an order of appearance of the commercials displayed on the commercial guide.

8. A computer readable storage medium storing instructions which, when executed on a programmed processor, carry out a process of implementing the commercial guide according to claim 1.

9. A method of displaying a commercial, comprising:
playing a segment of recorded video containing a plurality of commercials;
presenting a menu of available commercials;
receiving a selection from a user interface of a commercial selected from the plurality of commercials; and
playing the selected commercial.

10. The method according to claim 9, further comprising receiving a selection of a plurality of selected commercials.

11. The method according to claim 10, further comprising playing or resuming play of the segment of video after fully rendering the plurality of selected commercials.

12. The method according to claim 9, further comprising playing or resuming play of the segment of video after fully rendering the selected commercial.

13. The method according to claim 9, wherein the menu is generated by retrieving a list of commercials from a database.

14. The method according to claim 13, wherein the database is generated by retrieving commercial data from a transport stream during recording of the commercials.

15. An electronic storage medium storing instructions that, when executed on a programmed processor, carry out a process of displaying a commercial according to claim 9.

16. A method of displaying a commercial description, comprising:
receiving a user command to display a commercial description;
retrieving a commercial description stored in a computer file;
establishing a window on a display that covers a portion of the display; and
presenting the retrieved description within the window.

17. The method according to claim 16, further comprising, retrieving the commercial description from a commercial database.

18. The method according to claim 16, wherein the commercial description comprises at least one of a commercial title, a commercial category, a commercial start time, a commercial end time, a commercial duration, a key word, a commercial identifier, a commercial sponsor, a record file name, an offer associated with the commercial, and a commercial description.

19. The method according to claim 16, wherein the user command is received from a remote controller.

20. The method according to claim 16, wherein the user command is received in response to a user actuating a display button of a remote controller.

21. The method according to claim 16, further comprising receiving a second user command, and closing the window in response thereto.

22. The method according to claim 16, wherein the second command is identical to the first command.

23. The method according to claim 16, wherein the user command is received in response to a user actuating a display button of a remote controller, and wherein the second command is received as a result of a subsequent actuation of the display button of the remote controller.

24. The method according to claim 16, wherein the window is displayed for a specified period of time and then is closed.

25. A computer readable storage medium storing instructions which, when executed on a programmed processor, carry out a process according to claim 16.

26. An apparatus for displaying a commercial description, comprising:
a receiver for receiving a user command to display a commercial description;
a computer file storing commercial descriptions;
means for retrieving a commercial description stored in the computer file;
means for establishing a window on a display that covers a portion of the display; and
means for presenting the retrieved description within the window.

27. The apparatus according to claim 26, wherein the commercial description is retrieved from a commercial database.

28. The apparatus according to claim 26, wherein the commercial description comprises at least one of a commercial title, a commercial category, a commercial start time, a commercial end time, a commercial duration, a key word, a commercial identifier, a commercial sponsor, a record file name, an offer associated with the commercial, and a commercial description.

29. The apparatus according to claim 26, wherein the user command is received from a remote controller.

30. The apparatus according to claim 26, wherein the user command is received in response to a user actuating a display button of a remote controller.

31. The apparatus according to claim 26, further comprising receiving a second user command, and closing the window in response thereto.

32. The method according to claim 26, wherein the second command is identical to the first command.

33. The method according to claim 26, wherein the user command is received in response to a user actuating a display button of a remote controller, and wherein the second command is received as a result of a subsequent actuation of the display button of the remote controller.

34. The method according to claim 26, wherein the window is displayed for a specified period of time and then is closed.
